(19) United States
(12) Patent Application Publication
(10) Pub. No.: US 2026/0302969 A1
(43) Pub. Date: Oct. 1, 2026

(54) SYSTEMS AND METHODS FOR POWER CONVERSION WITH LC FILTER HAVING AN INDUCTOR WITH BOARD-EMBEDDED WINDING

(71) Applicant: The Trustees of Columbia University in the City of New York, New York, NY (US)

(72) Inventors: Matthias Preindl, New York, NY (US); Liwei Zhou, New York, NY (US); William-Michael Eull, Oakville, Ontario (CA); Matthew Jahnes, New York, NY (US)

(21) Appl. No.: 19/708,500

(22) Filed: Jun. 15, 2026

Related U.S. Application Data
(63) Continuation of application No. 18/292,317, filed on Jul. 27, 2022.
(60) Provisional application No. 63/226,059, filed on Jul. 27, 2021.
(60) Provisional application No. 63/226,136, filed on Jul. 27, 2021.
(60) Provisional application No. 63/242,840, filed on Sep. 10, 2021.
(60) Provisional application No. 63/270,311, filed on Oct. 21, 2021.
(60) Provisional application No. 63/319,122, filed on Mar. 11, 2022.
(60) Provisional application No. 63/345,896, filed on May 25, 2022.
(60) Provisional application No. 63/351,768, filed on Jun. 13, 2022.

(51) Int. Cl. H02M 7/5395; H02M 1/00; H02M 7/48; H02M 7/797

(52) U.S. Cl. CPC H02M 7/5395; H02M 1/0058; H02M 7/4803; H02M 7/797

(57) ABSTRACT

Disclosed are implementations that include a non-isolated power converter system comprising a filter including an inductor and a capacitor. The inductor of the filter includes a core portion and a winding portion. The core portion may include different shape core structures. The winding portion includes a winding embedded within a printed circuit board. The printed circuit board winding may include a litz wiring, and the printed circuit board having located thereon one or more of a controller or power switching elements.

### CROSS-REFERENCE TO RELATED APPLICATIONS

This application is a continuation of U.S. application Ser. No. 18/292,317, filed on Jan. 25, 2024, which represents the U.S. national stage entry of International Application No. PCT/US2022/038559 filed Jul. 27, 2022, which claims priority to U.S. Provisional Application No. 63/226,136, filed on Jul. 27, 2021, U.S. Provisional Application No. 63/242,840, filed on Sep. 10, 2021, U.S. Provisional Application No. 63/345,896, filed May 25, 2022, U.S. Provisional Application No. 63/351,768, filed on Jun. 13, 2022, U.S. Provisional Application No. 63/226,059, filed Jul. 27, 2021, U.S. Provisional Application No. 63/270,311, filed Oct. 21, 2021, and U.S. Provisional Application No. 63/319,122, filed Mar. 11, 2022, each of which is hereby incorporated by reference in its entirety.

### STATEMENT REGARDING FEDERALLY SPONSORED RESEARCH

This invention was made with government support under 1653574 awarded by the National Science Foundation. The government has certain rights in the invention.

### BACKGROUND

Power converters of various types have been produced and used in many industries and contexts. Example power converters include alternating current (AC) to direct current (DC) rectifiers, DC to AC inverters, and DC to DC converters. AC to DC rectifiers, also referred to as AC/DC rectifiers, converter AC power to DC power. DC to AC inverters, also referred to as DC/AC inverters, convert DC power to AC power. Power converters can be used for various purposes, such as rectifying AC power from an AC grid power source to DC power for charging a battery, or inverting DC power from a battery to AC power to drive a motor or supply AC power to an AC grid. Further, power converters can be used in various contexts, such as in or connected to an electric vehicle, an engine generator, solar panels, and the like.

### SUMMARY

Power converters may be described in terms of power conversion efficiency, power density, and cost, among other characteristics. Generally, it is desirable to have power converters with higher power efficiency, higher power density, and lower cost. A highly efficient power converter is able to convert power (e.g., AC to DC, DC to AC, and/or DC to DC) without significant losses in energy. A low efficiency power converter experiences higher losses in energy during the power conversion. Such energy losses may manifest as heat generated by the power converter while converting power, for example. Power efficiency for a power converter, inductor, or other electronic component may be expressed as a percentage between 0 and 100% and determined based on the power input to the component and the power output from the component using the equation:

$$Power Efficiency = \frac{Power Out}{Power In} .$$

A power converter with high power density has a high ratio of power output by the power converter compared to the physical space occupied by the power converter. The power density can be calculated using the equation:

$$Power Density = \frac{Power Out}{Volume of Power Converter} .$$

Energy costs, including monetary costs and environmental costs, continue to be an important factor across many industries that incorporate power converters. Accordingly, even slight increases (e.g., of tenths of a percent) in power efficiency for a power converter can be significant and highly desirable. Similarly, reductions in materials and size of power converters can be significant and highly desirable, allowing reductions in costs and physical space to accommodate power converters in systems that incorporate power converters.

In a power converter, an inductor that is part of an LC filter may accounts for a significant part of the total power losses of the converter. For high power applications, high frequency power converters with soft switching capabilities, the system efficiency can be highly related to the electromagnetic performance of the inductor. Additionally, the volume of an inductor of an LC filter can impact the power density of a power converter. The effective design of an inductor for soft switching can contribute to achieving higher efficiency, higher power density, and lower cost of the power converter. Some examples of the LC filter, and an inductor of the LC filter, described herein provide one or more benefits such as lower costs, improved voltage regulation, less power dissipation, improved ability to withstand heavy load currents, lower ripple factor, electromagnetic interference (EMI) reduction filter, filter higher power signals, and reduced or eliminated ventilation because less heat is produced in the inductor.

In one embodiment, a non-isolated power converter system comprises a power converter including power switching elements. A controller configured to drive the power switching elements to convert received power and to output converted power. The controller is configured to drive the power switching element using variable frequency soft switching (VFSS). A filter including an inductor and a capacitor is coupled to a first side of the power converter to filter power signals on the first side of the power converter. The signal received by the filter have a current ripple of at least 200% peak-to-peak ripple with respect to a local average current. The inductor of the filter includes a core portion and a winding portion. The winding portion includes a winding embedded in a printed circuit board.

In one embodiment, an inductor for a filter in a non-isolated power converter system comprises a core portion and a winding portion and the winding portion forms an inductor with the core portion. The winding portion includes a winding embedded in a printed circuit board and having a first terminal and a second terminal. The winding is embedded in the printed circuit board forming a litz PCB in which the winding includes multiple layers of parallel strands routed in the printed circuit board.

In one embodiment, an inductor for a filter in a non-isolated power converter system comprises a winding portion that includes a winding embedded in a printed circuit board and the winding forms a conductor loop including a first terminal and a second terminal. A core portion forms an inductor that includes a winding portion, and the core portion includes a first core portion and a second core portion on an opposite side of the winding portion. The first core portion and the second core portion include a planar surface facing the conductor loop and substantially parallel to the printed circuit board.

In one embodiment, an inductor for a filter in a non-isolated power converter system comprises a winding portion that includes a winding embedded in a printed circuit board and the winding forms a conductor loop including a first terminal and a second terminal. A core portion forms an inductor with the winding portion, and the core portion includes a first core portion opposite of an open-air portion. The first core portion includes a base portion and three legs extending therefrom, wherein a middle leg of the three legs extends through the opening defined by the conductor loop.

In one embodiment, a non-isolated power converter system comprises a power converter that includes a power switching element and a controller is configured to drive the power switching elements to convert received power and to output converted power. A filter includes an inductor and a capacitor, and the filter is coupled to a first side of the power converter to filter a power signal on the first side of the power converter. The inductor further includes a core portion and a winding portion. A printed circuit board includes an embedded winding portion and the printed circuit board having located one or more controller or one or more of the power switching element.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 illustrates a power converter system according to some embodiments.

FIG. 2 illustrates a modified half-bridge converter circuit according to some embodiments.

FIG. 3 illustrates a three phase DC/AC application with a LC filter according to some embodiments.

FIG. 4 illustrates a timing diagram and boundary conditions for soft switching according to some embodiments.

FIG. 5 illustrates a control diagram for controlling a pair of switching elements of a power converter according to some embodiments.

FIG. 6 illustrates another control diagram for controlling a pair of switching elements of a power converter according to some embodiments.

FIG. 7A illustrates an isometric view of an EE core inductor comprising copper wire windings.

FIG. 7B illustrates a perspective view of an EE core inductor comprising a winding embedded in a printed circuit board.

FIG. 8A illustrates an isometric view of an EI core inductor comprising a winding embedded in a printed circuit board.

FIG. 8B illustrates a perspective view of an EI core inductor comprising a winding embedded in a printed circuit board.

FIG. 9A illustrates an isometric view of an EA core inductor comprising a winding embedded in a printed circuit board.

FIG. 9B illustrates a perspective view of an EA core inductor comprising a winding embedded in a printed circuit board.

FIG. 10A illustrates an isometric view of an II core inductor comprising a winding embedded in a printed circuit board.

FIG. 10B illustrates a perspective view of an II core inductor comprising a winding embedded in a printed circuit board.

FIG. 11A illustrates an isometric view of an II core.

FIG. 11B illustrates an isometric view of an EA core.

FIG. 12 includes a plan view of a printed circuit board.

FIG. 13A illustrates a plan, perspective view of a solid winding embedded printed circuit board.

FIG. 13B illustrates a plan, perspective view of a litz winding embedded printed circuit board.

FIG. 14 illustrates an isometric view of a litz winding.

FIG. 15 illustrates an enlarged portion of the litz winding of FIG. 14.

FIG. 16 illustrates an isometric view of a litz winding comprising multiple layers.

FIG. 17 illustrates a resistance factor versus frequency plot according to the type of PCB windings and the number of PCB windings.

FIG. 18 illustrates an inductor loss versus volume comparison plot according to the type of core, the types of windings, and the number of windings.

FIG. 19 illustrates an inductor loss versus cost comparison plot according to the type of core, the types of windings, and the number of windings.

FIG. 20 illustrates an embedded winding portion of the inductor and having located one or more controller or one or more of the power switching element in a single printed circuit board.

FIG. 21 illustrates a process for power conversion according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “comprising,” “including,” “containing,” “having,” and variations thereof herein is meant to encompass the items listed thereafter and equivalents thereof as well as additional items. Additionally, the terms “connected” and “coupled” are used broadly and encompass both direct and indirect connecting and coupling, and may refer to physical or electrical connections or couplings. Furthermore, the phase “and/or” used with two or more items is intended to cover the items individually and both items together. For example, “a and/or b” is intended to cover: a (and not b); b (and not a); and a and b.

Disclosed herein are systems and methods related to power converters that can provide power conversion with increased power efficiency, increased power density, and/or reduced cost, among other advantages.

### I. Power Converter System

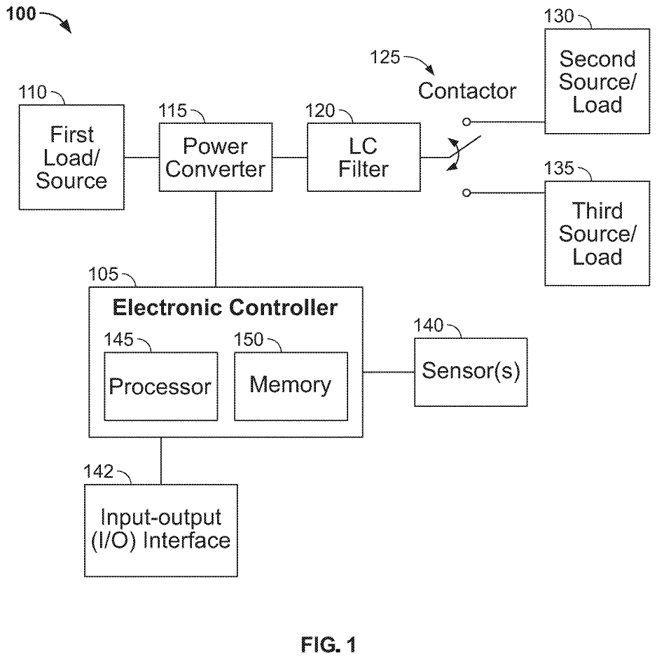

FIG. 1 illustrates a power converter system 100 in accordance with some embodiments. The power converter system 100 includes an electronic controller 105, a first load/source 110, a power converter 115, an LC filter 120, a contactor 125, a second source/load 130, a third source/load 135, and one or more sensors 140.

In operation, generally, the electronic controller 105 controls power switching elements of the power converter 115 with a high frequency control signals to convert power (i) from the first load/source 110 functioning as a source to the second source/load 130 or the third source/load 135 (depending on the state of the contactor 125) functioning as a load, or (ii) from the second source/load 130 or the third source/load 135 (depending on the state of the contactor 125) functioning as a source to the first load/source 110 functioning as a load. Accordingly, when the first load/source 110 is functioning as a source for the power converter 115, the second source/load 130 (or third source/load 135, depending on the state of the contactor 125) is functioning as a load for the power converter 115. Conversely, when the first load/source 110 is functioning as a load for the power converter 115, the second source/load 130 (or third source/load 135, depending on the state of the contactor 125) is functioning as a source for the power converter 115.

The first load/source 110 may be a direct power (DC) load, a DC source, or both a DC load and DC source (i.e., functioning as DC source in some instances and as a DC load in other instances, depending on the mode of the power converter 115). In some examples, the first load/source 110 is a battery. The second source/load 130 and the third source/load 135 may be a DC load, a DC source, both a DC load and DC source, an AC load, an AC source, or both an AC load and AC source (i.e., functioning as an AC source in some instances and as an AC load in other instances, depending on the mode of the power converter 115). In some examples, the second source/load 130 is an electric motor and the third source/load 135 is an AC generator or AC power supply grid. In some examples, the second source/load 130 and the third source/load 135 are both DC batteries. In some examples of the system 100, the second source/load 130 is connected to the LC filter 120 without the intermediate contactor 125, and the contactor 125 and the third source/load 135 are not present in the system 100.

The first load/source 110 is coupled to the power converter 115 at a first side of the power converter 115, and the second source/load 130 (or the third source load 135, depending on the state of the contactor 125) is coupled to the power converter 115 at a second side of the power converter 115. The first side may also be referred to as an input side or an output side of the power converter 115, depending on the mode of the power converter, or as a DC side of the power converter 115. The second side may also be referred to as an input side or an output side of the power converter, depending on the mode of the power converter, as a DC side or an AC side of the power converter 115, depending on the power type of the second and/or third source/load 130, 135, or as an interface side. In some embodiments, the second side of the power converter 115 may be an AC side having single phase AC power, three-phase AC power, or AC power with another number of phases.

In some embodiments, the power converter 115 operates with a high DC voltage level. For example, in operation, the DC side of the power converter 115 has a DC voltage (e.g., across input terminals of the power converter 115) of at least 200 V, at least 600 V, at least 800 V, at least 1000 V, at least 1200 V, between 200 V and 1200 V, between 600 V and 1200 V, between 800 V and 1200 V, or another range. Such high DC voltage levels may be desirable in some contexts, such as some electric vehicles. For example, some current electric vehicles (e.g., passenger vehicles and hybrid electric vehicles) operate with a DC bus voltage of between about 200 V and 400 V. This DC bus voltage for passenger electric vehicle may increase in the future. Further, some current electric vehicles (e.g., class 4-8, off-road, or otherwise larger electric vehicles) can operate with a DC bus voltage of more than 1000 V. However, high DC voltage levels may introduce challenges into a typical power converter system, such as an increase in leakage currents, increases in common mode voltage, higher rates of change in common mode voltage, and the like. When the second or third source/load is a motor (e.g., a traction motor in an electric vehicle), these challenges can lead to shaft voltages and bearing currents (e.g., from discharge events when lubricant dielectric breakdown occurs) that can result in bearing failures. Embodiments described herein, however, can mitigate such challenges through, for example, variable frequency soft switching, well-designed LC filters, and/or additional capacitors, as described herein. For example, in an electric vehicle context, embodiments described herein can reduce bearing currents and shaft voltages through controlling common mode voltage of the system to remain below a threshold and/or to maintain changes in common mode voltage below a rate of change threshold.

The sensor(s) 140 include, for example, one or more current sensors and/or one or more a voltage sensors. For example, the sensor(s) 140 may include a respective current sensor and/or voltage sensor to monitor a current and/or voltage of each phase of one or more of the first load/source 110, the second source/load 130, the third source/load 135, the LC filter 120, or the power converter 115. For example, when the LC filter 120 is a three-phase LC filter, the sensors 140 may include at least three current sensors, one for sensing current at each phase of a three phase LC filter 120. In some embodiments, additional or fewer sensors 140 are included in the system 100. For example, the sensors 140 may also include one or more vibration sensors, temperature sensors, and the like. In some examples, the controller 105 infers or estimates a characteristic (e.g., current or voltage) at one or more nodes of the power converter 114, rather than directly sensing the characteristic.

The input-output (I/O) interface 142 includes or is configured to receive input from one or more inputs (e.g., one or more buttons, switches, touch screen, keyboard, and the like), and/or includes or is configured to provide output to one or more outputs (e.g., LEDs, display screen, speakers, tactile generator, and the like). Other electronic devices and/or users may communicate with the system 100 and, in particular, the controller 105, via the I/O interface 142.

The electronic controller 105 includes an electronic processor 145 and a memory 150. The memory 150 includes one or more of a read only memory (ROM), random access memory (RAM), or other non-transitory computer-readable media. The electronic processor 145 is configured to, among other things, receive instructions and data from the memory 150 and execute the instructions to, for example, carry out the functionality of the controller 105 described herein, including the below-described processes. For example, the memory 150 includes control software. As described in further detail below, generally, the electronic processor 145 may be configured to execute the control software to monitor the system 100 including the power converter 115 (e.g., based on sensor data from the sensor(s) 140), receive commands (e.g., via the input/output interface 142), and to drive the power converter 115 (e.g., in accordance with sensor data and/or the commands). In some embodiments, instead of or in addition to executing software from the memory 150 to carry out the functionality of the controller 105 described herein, the electronic processor 145 includes one or more hardware circuit elements configured to perform some or all of this functionality.

Although the controller 105, the electronic processor 145, and the memory 150 are each illustrated as a respective, single unit, in some embodiments, one or more of these components is a distributed component. For example, in some embodiments, the electronic processor 145 includes one or more microprocessors and/or hardware circuit elements. For example, the controller 105 or electronic processor 145 may include a processor and a gate driver circuit, where the processor provides the gate driver circuit with a PWM duty cycle and/or frequency, and the gate driver circuit drives the power switching elements according to the PWM duty cycle and/or frequency.

### II. Upper Capacitor for Half-Bridge Switching Converter Topology

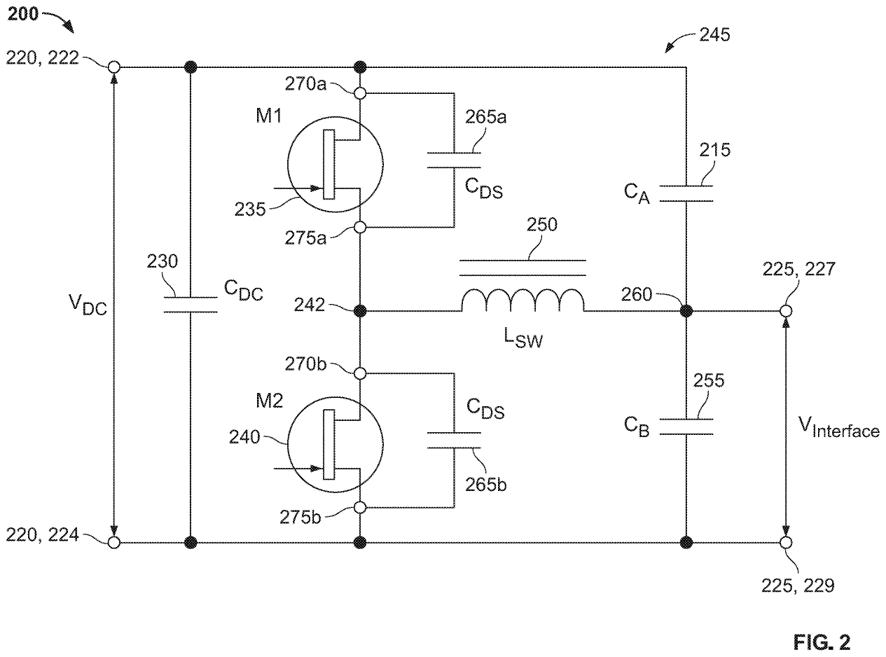

FIG. 2 illustrates an example of a half-bridge converter 200 that may serve as the power converter 115 of the system 100 of FIG. 1. As illustrated, the converter 200 includes DC terminals 220 (also referred to as DC nodes, DC links, DC rails, etc.) having a positive DC terminal 222 and a negative DC terminal 224. The converter 200 further includes interface terminals 225 (also referred to as interface nodes) having a positive interface terminal 227 and negative interface terminal 229. The converter 200 may be operated as a bidirectional converter or as a unidirectional converter (in either direction), depending on the configuration and control of the system in which it is implemented. Accordingly, the DC terminals 220 may be input terminals and the interface terminals 225 may be output terminals in some examples (e.g., DC/DC conversion and DC/AC inversion), and the DC terminals 220 may be output terminals and the interface terminals 225 may be input terminals in some examples (e.g., AC/DC rectification). Additionally, the interface terminals 225 may be AC input terminals (e.g., for AC/DC rectification), may be AC output terminals (e.g., for a DC/AC inverter), or may be DC output terminals (e.g., for DC/DC conversion).

The converter 200 further includes a DC link capacitor (CDC) 230, a, a high side (upper) power switching element (M1) 235 (also referred to as upper switch 235), a low side (lower) power switching element (M2) 240 (also referred to as lower switch 240), a midpoint node 242 connecting a drain terminal of upper switch 235 and a source terminal of lower switch 240, and an LC filter 245. The LC filter 245 is an example of the LC filter 120 of the system 100 of FIG. 1.

The power switching elements 235 and 240 may be field effect transistors (FETs), each having a respective gate, source, and drain terminal. The FETs may be, for example, a MOSFET, a silicon carbide (SiC) FET, a gallium nitride (GaN) FET, among other types of FETs.

The LC filter 245 includes a switch-side inductor LF 250, a lower capacitor CB 255, and an upper capacitor CA 215. The switch-side inductor LF 250 is coupled between the midpoint node 242 and a filter node 260. For example, a first end of the switch-side inductor LF 250 is coupled to the midpoint node 242, and a second end is coupled to the filter node 260. The lower capacitor CB 255 is coupled between the midpoint node 242 and the negative DC terminal 224. For example, a first end of the lower capacitor CB 255 is coupled to the midpoint node 242, and a second end is coupled to the negative DC terminal 224. The upper capacitor CA 215 is coupled between the midpoint node 242 and the positive DC terminal 222. For example, a first end of the lower capacitor CA 255 is coupled to the midpoint node 242, and a second end is coupled to the positive DC terminal 222.

In some examples, the LC filter 245 is an LCL filter (an LC filter with an additional inductor (L)), in which an additional (interface) inductor is coupled between the filter node 260 and the positive interface terminal 227.

The converter further includes drain-source capacitors Cps 265a and 265b, each respectively coupled across one of the switches 235, 240. In particular, a first drain-source capacitor 265a is provided across a source terminal 270a and drain terminal 275a of the upper switch (M1) 235, and a second drain-source capacitor 265b is provided across a source terminal 270b and drain terminal 275b of the lower switch (M2) 240. The drain-source capacitors (C_{DS}) 265a-b may be generically and collectively referred to herein as drain-source capacitor(s) (C_{DS}) 265.

This upper capacitor 215 allows for the ripple currents at both input nodes and output nodes (nodes 222, 227) of the converter 200 to be shared. Because the ripple currents on the input nodes and the rippler currents on the output nodes have some correlation, differential mode currents of these input and output nodes can be canceled through this capacitance. This reduction in differential mode current can result in improved EMI performance and decreased total capacitor ripple current when compared with a typical half-bridge converter (e.g., when the total capacitance between the two converters is held constant). Furthermore, the reduction in total capacitor ripple current can allow for a decrease in capacitor size, for example, when capacitor ripple current drives capacitor sizing.

The drain-source capacitors (C_{DS}) 265 can slow a voltage rise during an ON-to-OFF transition of the switches 235 and 240. This slowed voltage rise can, in turn, reduce the switching losses of the switches 235 and 240.

In some examples of the converter 200, one or both of the upper capacitor CA 215 and the drain-source capacitors Cps are not included in the converter 200.

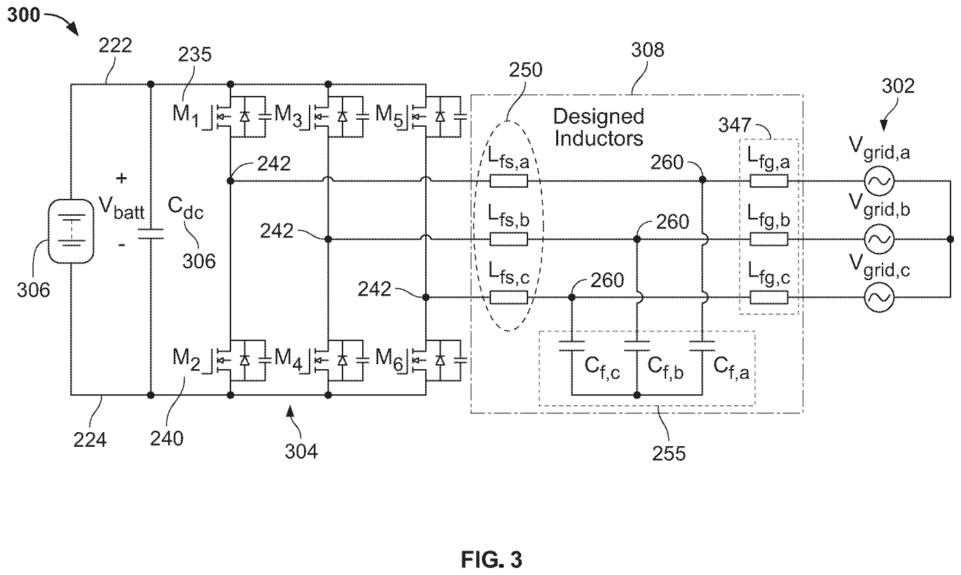

As noted, in some examples, the power converter 200 may serve as the power converter 115 of the system 100 in FIG. 1. In the context of the power converter 115 (and, thus, the power converter 200) implementing an AC/DC rectifier or a DC/AC inverter, the power converter 200 is a single-phase power converter 200. In some examples, multiple instances of the power converter 200 are paralleled to collectively serve as the power converter 115 of FIG. 1 and provide the single-phase conversion (whether rectification or inversion) or to provide a DC/DC power conversion. In some examples, the power converter 115 is a multiphase power converter (e.g., operating with three or more phases of AC power). In such examples, the power converter 115 may include multiple instances of the power converter 200, each instance associated with a phase of the AC power, each instance having shared DC terminals 220, and each instance having independent V_{interface} nodes 225. An example of such a power converter is provided in FIG. 3. In some of these examples, multiple instances of the power converter 200 are paralleled to collectively provide the power conversion for a respective phase (e.g., two parallel power converters 200 for phase 1, two parallel power converters 200 for phase 2, and two parallel power converters 200 for phase 2). In some examples, the particular number of parallel power converter 200 and the number of phases varies. provide the single-phase conversion (whether rectification or inversion) or to provide a DC/DC power conversion.

FIG. 3 illustrates a multiphase power converter system 300. The multiphase converter system 300 includes a multiphase converter 304 coupled to a battery 306 on a DC side and coupled to the AC grid 302 via LCL filters 308. The multiphase converter 304 may serve as the power converter 115 of the system 100 in FIG. 1, and the LCL filters 308 may serve as the LC filter 120 of the system 100 of FIG. 1. In operation, the multiphase converter 300 may function as a DC/AC inverter or an AC/DC rectifier, depending on the sources and switching of the power switching elements.

The multiphase converter 304 includes three instances of the power converter 200 of FIG. 2, one for each phase of the AC grid 302. Each instance includes an upper and a lower switch 235 and 240, with drain-source capacitors coupled across each of these switches. The multiphase converter 300 is further coupled, via the DC terminals 220, to the battery 310, and via the interface terminals 225 to the AC grid 302. The multiphase converter 300 includes three LCL filters 308. Each LCL filter 308 includes components similar to the LC filter 245 of FIG. 2, with the addition of an interface inductor (L_{fg}) 347 coupled between the filter node 260 and the AC grid 302. That is, each LCL filter 308 includes a switch-side inductor 250 (also labeled L_{fs,a}, L_{fs,b}, or L_{fs,c}), a lower capacitor 255 (also labeled C_{f,a}, C_{f,b}, and C_{f,c}), an upper capacitor 215 (also labeled C_{f,a}, C_{f,b}, or C_{f,c}). The switch-side inductor 250 is coupled between the midpoint node 242 and the filter node 260.

In the illustrated example, the multiphase converter 300 is coupled to the battery 306 and the AC grid 302. In other examples, the multiphase converter 300 is coupled to a DC source/load other than the battery 306 (e.g., a capacitor, ultracapacitor, DC power supply from rectified AC power, etc.) and/or to an AC source/load other than the grid 302 (e.g., a three-phase motor, an engine generator, etc.). Additionally, although the multiphase converter 300 includes the drain-source capacitors for each switch, and the interface inductor 347 for each phase, in some examples, one or more of these components are not included. Additionally, in some embodiments, an upper capacitor 215 for each phase is coupled between each filter node 260 and the positive DC node 222, such as shown FIG. 2 (for a single phase).

### III. Variable Frequency Critical Soft-Switching

In some examples, the half-bridge power converter 200 and/or multiphase power converter 300 are driven using a variable frequency critical soft switching (VFCSS) scheme. The VFCSS scheme can provide improved efficiency and reduced filter volume (i.e., improved power density) for the power converter. Soft switching allows for the substitution of turn-on switching losses for turn-off switching losses, which is beneficial as turn-on losses for SiC devices are typically much greater than turn-off losses. This VFCSS technique makes possible an increase in switching frequency (e.g., by a factor of 5) and a reduction in inductance (e.g., by a factor of 20) while reducing the FET loss, which results in improved power density and efficiency.

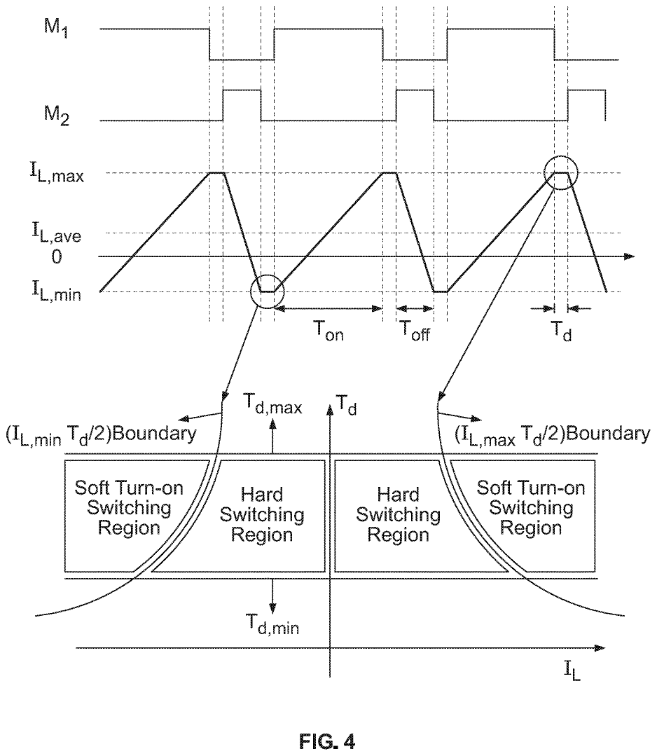

VFCSS is implemented by varying the switching frequency to achieve a desired inductor ripple current in the LC filter (e.g., in the switch-side inductor 250 of the LC filter 245). The desired inductor ripple current may be derived such that the valley point of the inductor current reaches a predetermined value of inductor threshold current I_{L,thr}. I_{L,thr} is set in accordance with the boundary conditions of dead time and peak/valley inductor current for inductor 250, which can be derived from the switching elements 235, 240 output capacitance. FIG. 4 shows the boundary relationships of the dead time (Ta) and peak and valley inductor current I_{L,max} and I_{L,min}, respectively. Inductor current and dead time values that result in soft switching are identified as soft turn-on switching areas or regions, and inductor current and dead time values that do not result in soft switching are identified as hard switching areas or regions. The soft switching regions represent the areas of operation where there is sufficient time and current for discharging the output capacitance of the power switching element (M1 or M2) before it is turned on. Analytically, these boundaries are expressed as

$$1 / 2 {I}_{L , max} {T}_{d} \leq {Q}_{min} \leq 0 ,$$

$$1 / 2 {I}_{L , min} {T}_{d} \geq {Q}_{max} \geq 0 ,$$

where Qₘᵢₙ and Qₘₐₓ are the minimum discharge thresholds of the switch output capacitance for the soft switching.

For high positive values of DC inductor current, a large current ripple is required to maintain a valley inductor current point that is lower than the threshold current level −I_{L,thr}. The negative inductor current will discharge the upper switch output capacitance in the turn-off transient period of the lower switch. Similarly, for high negative values of DC inductor current, a large current ripple is also required to ensure the peak inductor current point is greater than the threshold current I_{L,thr}. Zero voltage switching (ZVS) of the lower switch will be achieved if the lower switch output capacitance is fully discharged by the positive inductor current during the turn-off transient of the upper switch. Generally, to achieve full soft switching over an entire cycle (e.g., an entire grid cycle), the current ripple should be sufficiently large to guarantee bidirectional inductor current paths, or the dead time needs to be expanded. As unnecessarily large dead times can result in distortion, VFCSS adjusts the switching frequency to maintain critical soft switching over the full cycle. The VFCSS scheme is implemented to maintain a positive threshold current during the negative portion of the cycle and a negative threshold current during the positive portion of the cycle. The switching frequency to achieve this for an arbitrary threshold value can be calculated with the following equation:

$${f}_{sw} = \frac{( 1 - d ) {dV}_{dc}}{2 ( \vert {I}_{L} \vert + {I}_{L , thr} ) {L}_{f}} ,$$

where I_{L,thr} is the boundary threshold current for soft switching, which can be derived from FIG. 4 with a given dead time (T_{d}), and I_{L} is the inductor current, and where d is the reference duty cycle (a value between 0 and 1).

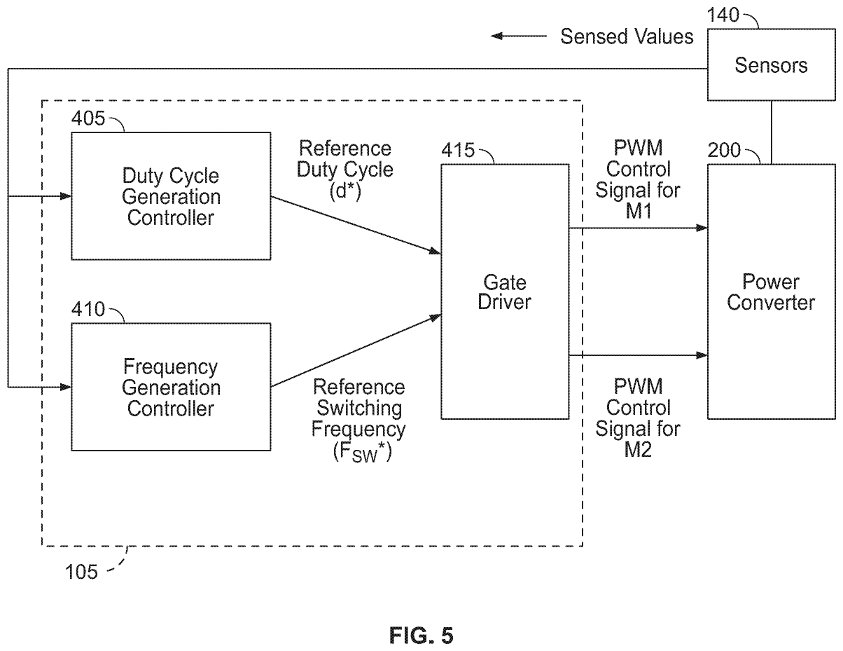

FIG. 5 illustrates a control diagram for controlling a pair of switching elements of a power converter. In particular, the control diagram illustrates an example of the controller 105 implementing an example control scheme for VFCSS control of the power converter 200 including the upper capacitor 215. The controller 105 includes a duty cycle generation controller 405 and a frequency generation controller 410, which may be regulators for generating, respectively, a reference duty cycle (d*) and a reference switching frequency (Fsw*). The duty cycle generation controller 405 may generate the reference duty cycle (d*) based on sensed (or estimated) characteristics of the power converter 200, such as currents and/or voltages. For example, the duty cycle generation controller 405 may implement a PID controller, or another type of regulator. The frequency generation controller 410 may generate the reference switching frequency (Fsw*) based on sensed (or estimated) characteristics of the power converter 200 and the above noted equation for calculating Fsw*. The gate driver 415 receives the reference duty cycle (d*) and a reference switching frequency (Fsw*) from the controllers 405 and 410, respectively. Based on these received reference values, the gate driver 415 generates a first PWM control signal for the upper switch (M1) 235 and a second PWM control signal for the lower switch (M2) 240. For example, the gate driver 415 generates the first PWM control signal having a frequency (FSW) equal to the reference switching frequency, and with a duty cycle (d₁) equal to the reference duty cycle (d*). Similarly, the gate driver 415 generates the second PWM control signal having the frequency (fsw) equal to the reference switching frequency (fsw*), and with a duty cycle d₂ equal to 1−d₁−(T_{d}/f_{sw}), and where the ON edge of the second PWM control signal lags the OFF edge of the first PWM control signal by a time T_{d}/2, and the OFF edge of the second PWM control signal leads the ON edge of the PWM signal by a time T_{d}/2.

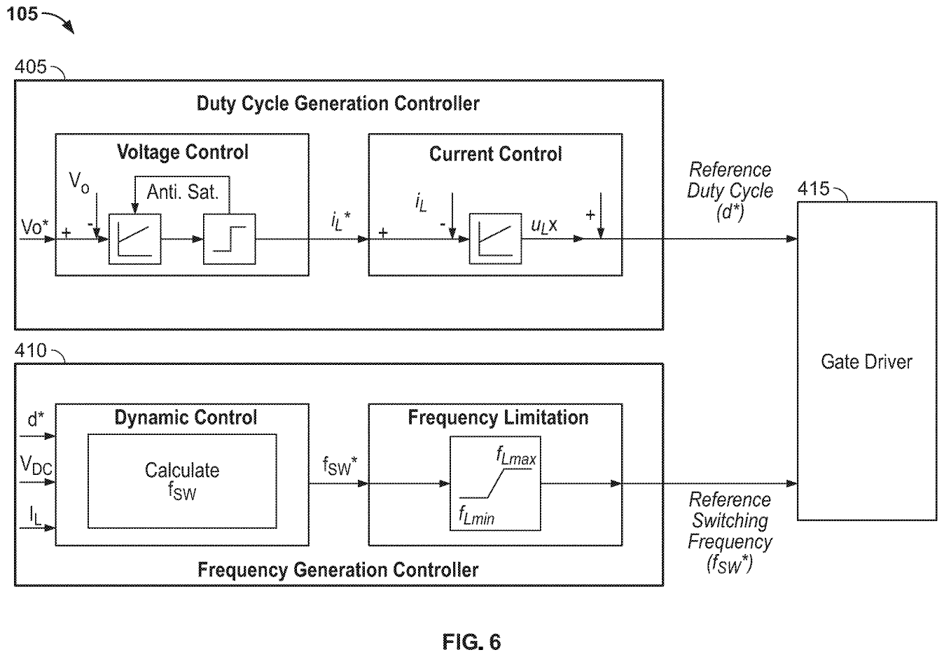

FIG. 6 illustrates another control diagram for controlling a pair of switching elements of a power converter. In particular, the control diagram illustrates a more detailed example of the controller 105 implementing VFCSS control as provided with respect to FIG. 5. FIG. 6 is merely one example of an implementation of the controller 105 to implement VFCSS and, in other embodiments, the controller 105 implements VFCSS with other approaches. For example, different regulators may be used to generate the reference duty cycle and reference switching frequency than those shown in FIG. 6.

In the example of FIG. 6, the duty cycle generation controller 405 includes a two-stage regulator with a first voltage regulation stage that compares a reference output voltage to a sensed output voltage of the converter (e.g., Vo at interface terminals 225), and generates a reference inductor current (I_{L}*). A second current regulation stage receives and compares the reference inductor current (I_{L}*) to a sensed inductor current (I_{L}) of inductor 250 and generates the reference duty cycle (d*).

Also, in the example of FIG. 6, the frequency generation controller 410 determines the reference switching frequency (fsw) using the above-provided equation. In some examples, the frequency generation controller 410 dynamically computes the equation to generate the reference switching frequency (fsw), and in other examples, a lookup table is provided to map the inputs of the frequency generation controller 410 to a particular value for the reference switching frequency (fsw). In the frequency generation controller 410, a frequency limiter stage is also provided that limits the reference switching frequency (fsw) to a maximum and minimum value.

Like in FIG. 6, the gate driver 415 receives the reference duty cycle (d*) and the reference switching frequency (fsw). The gate driver 415 then generates the PWM control signals to drive the power switching elements of the power converter 200, as previously described.

In a power converter, an inductor accounts for a significant part of the total power losses. For high power applications, high frequency power converters with soft switching capabilities, the system efficiency can be highly related to the electromagnetic performance of the inductor. Additionally, and alternatively, the volume of the inductor can impact the power density of the energy conversion system. The effective design of an inductor for soft switching contributes to achieve higher efficiency, higher power density, and lower cost of the power converter. By combining inductors and capacitor components with opposite properties, noise can be reduced, and specific signals can be identified. Some examples of the LC filter described herein provides one or more benefits such as lower costs, improved voltage regulation, less power dissipation, improved ability to withstand heavy load currents, lower ripple factor, filter higher power signals, and reduced or eliminated ventilation because less heat is produced in the inductor.

### IV. LC Filter Inductor

A conventional inductor includes a coil wound around a core. When the currents start flowing into the coil, the coil starts to build up a magnetic field. The electromagnetic storage capacity of the conventional inductor is controlled by the number of coils wrapped around the core, the ferrous material, the diameter of the coil, and the magnetic wire length of the coil.

### A. Core for LC Filter Inductor

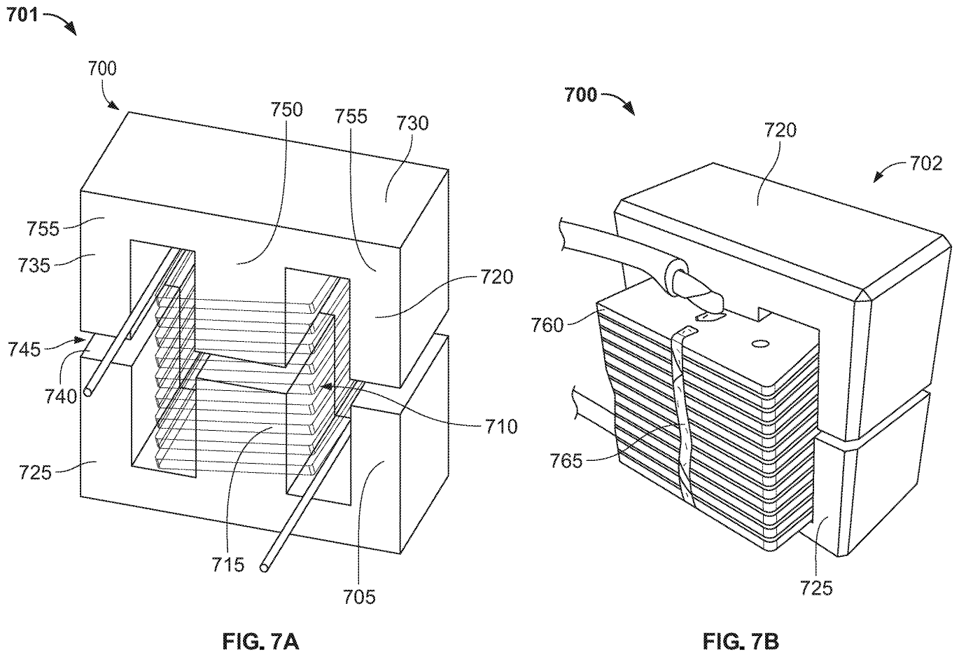

Referring to FIGS. 7A and 7B, an “EE” shape core 700 is illustrated as part of an inductor 701 and an inductor 702, respectively. Specific ally referring to FIG. 7A, the inductor 701 includes a core portion 705 that receives a winding portion 710. The core portion of the various inductors provided herein make take various shapes. The core portion 705 of FIG. 7A includes the “EE” shape core 700. The winding portion 710 includes a wire inductor 715, which may be a litz wire or solid (cross-section) copper wire, is wound on the “EE” shape core 700. The “EE” shape core 700 includes a first portion 720 and a second portion 725, each portion shaped like an “E” having a base 730 with three legs 735 extending away from the base 730. The legs 735 and base 730 may each have a generally rectangular cuboid shape. A distal end 740 of respective legs 735 of the first portion 720 and the second portion 725 are positioned across from one another, separated by an air gap 745, with the base 730 of the two portions 720, 725 on opposite ends of the “EE” shape core 700. A middle leg 750 and an outer most legs 755 are parallel to one another, and the thickness of the middle leg 750 may be different from the outer-most legs 755.

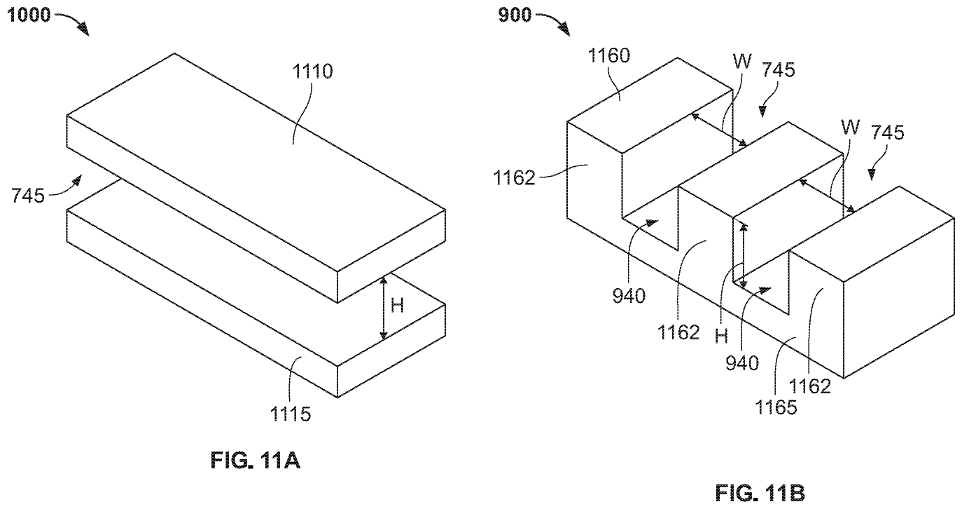

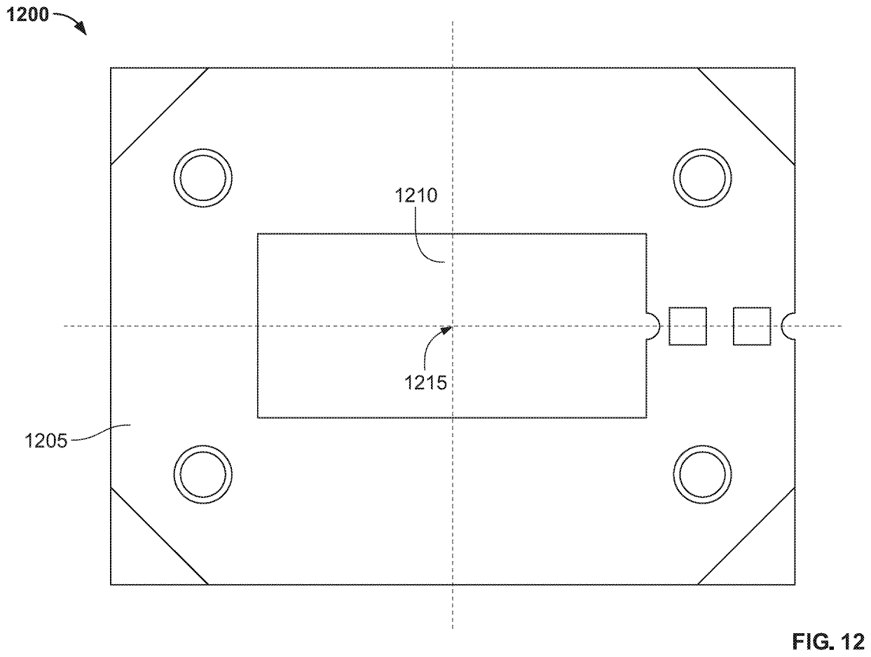

The “EE” core, like other cores provided herein, may also be combined with a winding portion including or formed by a PCB winding. Specifically referring to FIG. 7B, the inductor 702 having the “EE” shape core 700 (as a core portion) and PCB windings 760 (as a winding portion) is illustrated. A conductive tape 765 is used to connect the PCB windings 760. The PCB windings 760 includes embedded wiring, which is discussed in more detail below and through FIGS. 11 and 12.

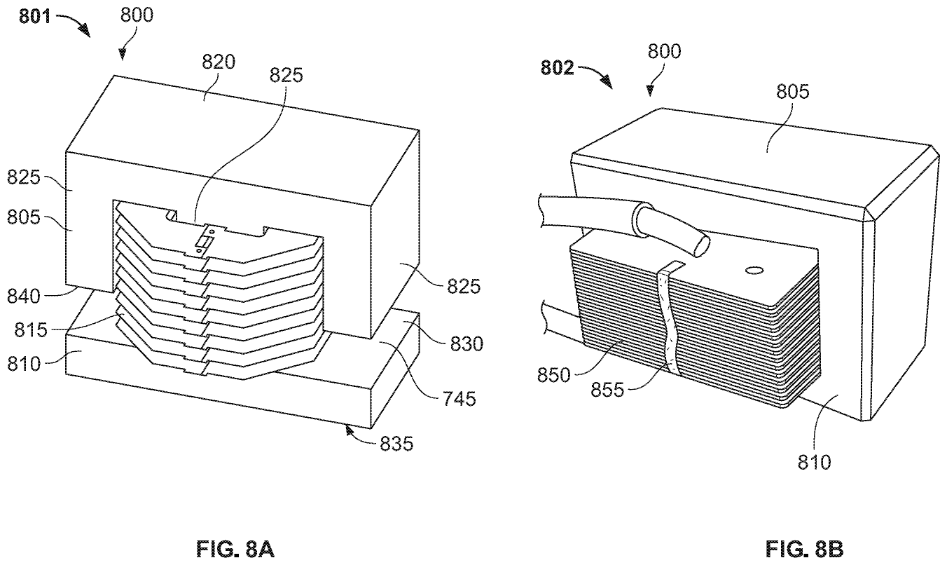

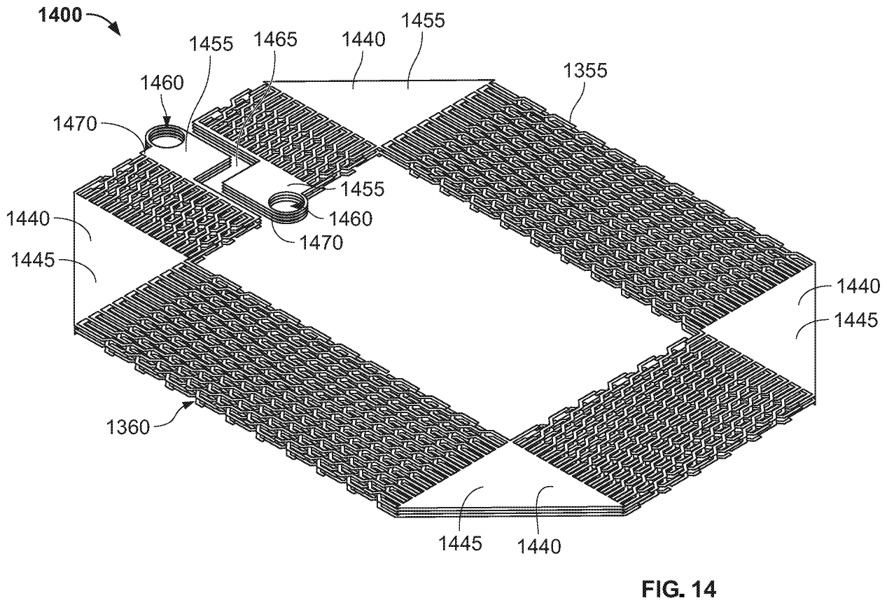

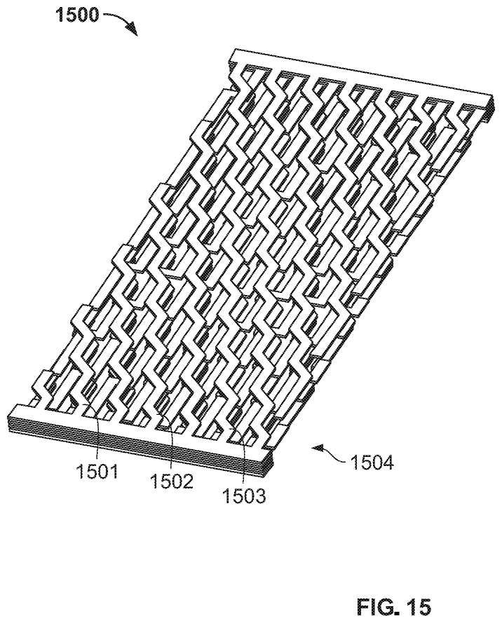

Referring to FIGS. 8A and 8B, an “EI” shape core 800 is illustrated as part of an inductor 801 and an inductor 802, respectively. The “EI” shape core 800 includes a first portion 805 and a second portion 810. Specifically referring to FIG. 8A, the inductor 801 having the “EI” shape core 800 (as a core portion) and a litz PCB winding 815 (as a winding portion) is illustrated. The litz PCB winding 815 is discussed in more detail below and through FIGS. 14-15. The first portion 805 of the core 800 is shaped like an “E,” which includes a base 820 with three legs 825 extending away from the base 820. The second portion 810 is shaped like an “I,” which includes a rectangular cuboid shape that is similar to the shape of the base 820 of the first portion 805 without the legs 825. The base 820 includes or defines a first surface 830 and a second surface 835. A distal end 840 of the legs 825 of the first portion 805 projects away from the base 820 of the first portion 805 towards one of the surfaces of the second portion 810 (e.g., towards the surface 830). The first portion 805 and the second portion 810 are separated by an air gap 745. Additionally, the second portion 810 and the base 820 of the first portion 805 are parallel and are on opposite ends of the inductor.

Specifically referring to FIG. 8B, the inductor 802 having the “EI” shape core 800 (as a core portion) and a PCB winding 850 (as a winding portion) is illustrated. A conductive tape 855 may be used to connect the PCB windings 850. The PCB windings 850 include embedded wiring, which is discussed in more detail below and through FIGS. 11 and 12.

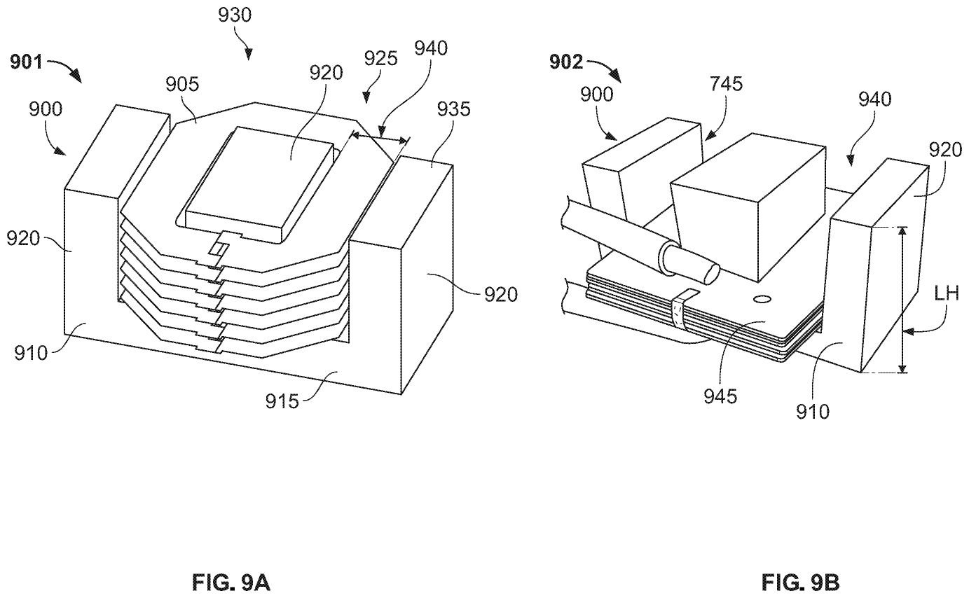

Referring to FIGS. 9A and 9B, an “EA” shape core 900 is illustrated as part of an inductor 901 and an inductor 902, respectively. Specifically referring to FIG. 9A, the inductor 901 having the “EA” shape core 900 (as a core portion) and litz PCB windings 905 (as a winding portion) is illustrated. The “EA” shape core 900 includes a first potion 910 that is shaped like an “E” having a base 915 with three legs 920 extending away from the base 915. The “EA” shape core 900 further includes an air portion 925 representing the “A” of the “EA” shape core 900 and is open on a side 930 of the inductor 901. With the three legs 920 extending from the base 915 of the “EA” shape core 900, the air portion 925 is adjacent to a distal end 935 of the three legs 920 extending from the base 915 and is opposite the base 915 of the “E” shape core. Between the three legs 920, a window 940 is formed. The window receives the PCB windings 905 and, with the height of the legs 920, can define or limit the height of the stacked PCB windings.

Specifically referring to FIG. 9B, the inductor 902 having the “EA” shape core 900 (as a core portion) and PCB printed inductors 945 (as a PCB portion) is illustrated. An air gap 745 may be present between each pair of the extending legs 920 of the “EA” shape core 900. A height of the air gaps 745 of the “EA” 900 shape core may be adjusted by altering a leg height LH (or extension length from the base 915) of the legs 920 or by inserting additional layers of PCB printed inductor 945 windings. For example, compared to the inductor 902, the inductor 901 of FIG. 9A has a minimal air gap because the height of the PCB windings 905 is nearly the same height as the legs 920. This air gap height, of both inductors, is larger in some examples and shorter in other examples (e.g., based on the height of the legs 920 and the number of PCB layers 905,945).

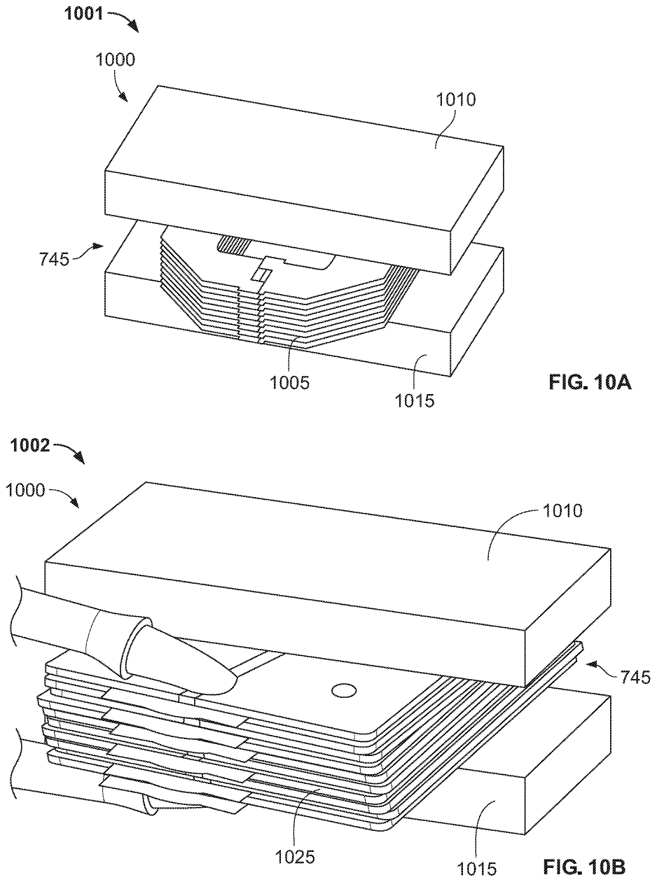

Referring to FIGS. 10A and 10B, an “II” shape core 1000 is illustrated as part of an inductor 1001 and 1002, respectively. Specifically referring to FIG. 10A, the inductor 1001 having the “II” shape core 1000 (as a core portion) and litz PCB windings 1005 (as a winding portion) is illustrated. The “II” shape core 1000 includes a first portion 1010 and a second portion 1015, each portion shaped like an “I” that has a generally rectangular cuboid shape. The first portion 1010 and the second portion 1015 of the “II” shaped core are spaced apart from another by an air gap 745. The litz PCB windings 1005 are sandwiched between the first “I” portion 1010 and the second “I” portion 1015. In this inductor 1001, the core includes no legs inserted into or through the winding portion and the winding portion is not wound around a portion of the core 1000.

Specifically referring to FIG. 10B, the inductor 1002 includes the “II” shape core 1000 (as a core portion) and a PCB winding 1025 (as a winding portion) is sandwiched between the first portion 1010 and the second portion 1015 of the “II” shaped core 1000, in an air gap 745. Like the inductor 1001, in the inductor 1002, the core includes no legs inserted into or through the winding portion and the winding portion is not wound around a portion of the core 1000.

The different core shapes and compositions provide different advantages and tradeoffs. For example, referring FIGS. 7A and 7B, the “EE” shape core 700 has a larger volume and more material than the other core shapes (e.g., “EA,” “EI,” and “II”), increasing cost and overall size of the inductors 701 and 702 that include this core. However, the “EE” shape core 700 can allow for a larger height (or window) for windings, which allows more windings that could be stacked parallel to decrease the coil resistance and copper losses.

Referring to the “II” shape core 1000 of FIG. 11A, the “II” shape core 1000 has a smaller volume than the other core shapes (e.g., “EA,” “EI,” and “EE”), resulting in reduced material costs and inductor size. However, the “II” shape core includes the smallest air gap 745, limiting the number of turns of the winding portion (whether wrapped wire or stacked PCBs). Therefore, the number of turns of the winding and the air gap 745 can be carefully designed to support the desired inductance for the reduction of copper losses. Still referring to FIG. 11A, the air gap 745 between a first “I” shape portion 1110 and second “I” shape portion 1115 may be determined by a height H of windings, which may be determined by the number of PCB windings.

Referring to the “EI” shape core 800 (of FIGS. 8A and 8B), the “EI” shape core 800 is a hybrid of the “EE” shape core 700 and the “II” shape core 1000 that may be used to reduce the volume cost (of the “EE” shape) and copper losses (of the “II” shape). The “EI” shape core 800 enables the PCB printed windings to be stacked while providing the benefits of being able to increase the air gap 745 larger (and include more windings) than with an “II” shape.

Referring to the “EA” shape core 900 of FIG. 11B, the “EA” shape core 900 includes an air gap 745 that is restricted by an open area 1150 on top of a “E” shape core (e.g., an area defined by a plane extending across distal ends 1160 of legs 1162). Accordingly, stated another way, the air gap 745 is limited by the length of the legs 1162 (or extension fo the legs 1162 from a base 1165). The “E” shape core 900 defines a magnetic flux path that, at least in some examples, only goes through two window widths (W) on top of the “E” shape core 900 to finish the flux loop. Therefore, in at least some examples, the number of PCB printed windings may not exceed a height H between the distal end 1160 of the three legs 1162 and the base 1165. In some examples, the air gap 745 of the “EA” shape core 900 is approximately the same as a width W of the window 940, and the “EA” shape core 900 uses less magnetic (core) material than an “EE” shape (50% reduction) and than an “EI” shape, thereby reducing the cost and volume of the inductor.

Although the inductors of FIGS. 7B through 10B are illustrated having a particular size and number of PCB windings, the particular sizes and number of PCB windings varies in some examples. For examples, more or fewer PCB windings may be provided in these inductors of FIGS. 7B through 10B, in some examples. Additionally, the particular length of the legs or spacing between legs of the “E” shaped bases, or the particular lengths, widths, and heights of the “I” shaped bases of the cores may increase or decrease in some examples.

### B. Winding for LC Filter Inductor

The inductor design of the present disclosure includes a winding portion around one of the cores mentioned above. Unlike a conventional inductor comprising a wire wound coil, the present disclosure includes a printed circuit board (PCB) winding, such as PCB winding 1200 of FIG. 12, comprising a circuit board or substrate 1205 having an embedded inductor winding (not illustrated in FIG. 12). The circuit board 1205 of the PCB winding 1200 includes or defines an aperture 1210 disposed around a center of the PCB winding 1215. For example, in FIG. 12, the aperture 1210 is a rectangular shape, but may comprise different shapes such as a circle, oval or triangle, or may not be present, in some examples. Similarly, the perimeter shape of the circuit board 1205 may vary from the rectangular shape shown in FIG. 12 and, instead, may be a circle, oval, triangle, etc. An inductor including the PCB winding 1200 comprising an embedded winding provides various advantages over conventional wire-wound inductors such as, but not limited to, low-cost, more durable windings, and reduced complexity of mass production.

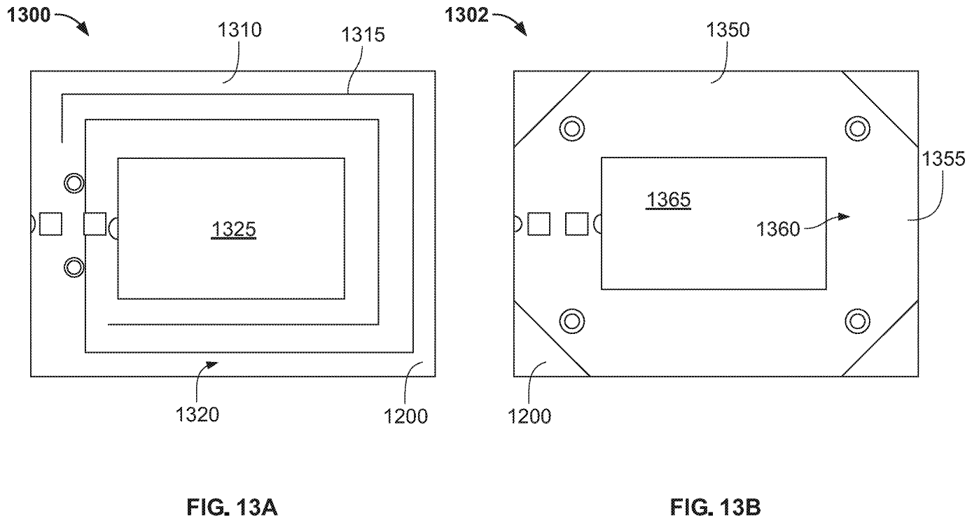

FIGS. 13A and 13B illustrates a PCB winding 1300 and 1302, respectively, which may be examples of the PCB winding 1200. The embedded windings of the PCB windings 1300 and 1302 comprise a conductive material such as copper, ferrite material, or another material having similar properties (e.g., low power loss density). The embedded windings may have a structure of, for example, a rectangular foil solid conductor, a round wire solid conductor, and a round litz wire conductor.

The PCB winding 1300 of FIG. 13A may be referred to as a solid PCB winding 1300 that includes a circuit board 1310 with a solid round wire conductor 1315 embedded therein. The solid round wire conductor 1315 extends in a rectangular spiral 1320 within on the circuit board 1310, around an aperture 1325 of the circuit board 1310. The number of loops that the solid round wire conductor 1315 traverses on the circuit board 1310 may vary based on design considerations for the inductor. For example, generally, the more loops, the more inductance that the inductor will provide. Within the board 1310, the embedded solid wire conductor 1315 may form multiple loops both through one or both of (i) multiple vertical layers of the circuit board 1310, so that the loops are stacked above/below each other, and (2) within a single layer, forming loops with different diameters (e.g., in the case of 2 loops, as shown in FIG. 13A, the wire forms an inner and outer loop on a single layer).

The PCB winding 1302 of FIG. 13B, may be referred to as a litz PCB winding 1302. The litz PCB winding 1302 includes a circuit board 1350 with a litz conductor 1355 embedded therein. As explained further below, the litz conductor 1355 has properties similar to a litz wire, which is a wire with a plurality of parallel strands that are insulated from one another (e.g., by an insulating sleeve) along the length of the wire. Accordingly, the conductor 1355 is referred to as a litz wire conductor 1355 or litz conductor 1355 herein. The litz wire conductor 1355 creates a woven pattern 1360 within the circuit board 1350. The litz wire conductor 1355, and its woven pattern 1360, may extend around an aperture 1365 of the circuit board 1350. The size of the apertures 1210, 1325, 1365 may be larger than the thickness of the middle leg 750 of the “E” shape core as shown in FIG. 7A such that the middle leg 750 may pass through the apertures 1210, 1325, and 1365. The litz wire conductor 1355 of the litz PCB winding 1302 may include one or more layers of the woven pattern 1360, for example, as detailed further below with respect to FIGS. 14-16.

The solid PCB winding 1300 and the litz PCB winding 1302 provide different AC resistance, which is relevant to the acceptable or desirable frequency of the current excitation. A higher frequency will result in a thinner skin depth, which can affect the revised penetration ratio and influence the skin and proximity effect factors. The penetration ratio, switching frequency, and the number of turns and/or PCB winding layers influence the resistance factor.

The litz wire conductor 1355 used in the litz PCB winding 1302 can reduce and/or eliminate AC resistance of an inductor, as compared to the solid round wire conductors 1315 of the solid wire PCB winding 1300. The litz wire conductor 1355 can be fabricated by twisting multiple strands of wires to reduce the skin and proximity effects. With respect to the skin effect, because each strand has much smaller cross-sectional area, the thickness of the skin is negligible compared to the diameter of the litz wire conductor 1355. The proximity effect in the litz conductor 1355 is limited by the evenly distributed strands counteracting the magnetic field in adjacent strands. Therefore, the litz wire conductor 1355 decreases both skin and proximity effects, and reduces AC losses in comparison to a solid wire winding, whether wound (like FIG. 7A) or embedded in a solid wire PCB (like FIG. 13A). The solid wire PCB winding 1300, however, may be manufactured with less complexity, when compared to the liz PCB winding 1302.

Referring to FIG. 14, a three-dimensional (3D) routed litz PCB winding 1400 comprising the litz wire conductor 1355 is shown. In FIG. 14, a 3D litz PCB routing technique is employed to provide the litz wire conductor 1355 having the pattern 1360 noted above with respect to FIG. 13B. The pattern 1360 is formed by a plurality of strands that, collectively, form the litz wire conductor 1355. The 3D routed PCB winding 1400 provides benefits such as inherent insulation capability, convenience of assembly, and high window space utilization, and the litz wire provides benefits such as reduction of AC losses, as described above. The 3D litz PCB routing technique uses a litz structure of round twisted wire that is embedded and routed through multiple layers of the circuit board 1350 (although the circuit board 1350 is not shown in FIG. 14 to highlight the litz structure). The 3D litz PCB is routed in consideration of magnetic field generated by the strands of the litz conductor 1355. For example, each strand of the litz conductor in the circuit board 1350 may pass through all the layers of the circuit board 1350 evenly in a spiral to counteract the adjacent magnetic field of adjacent strands of the litz conductor 1355. Further, the length of each strand of the litz conductor 1355 may be the substantially the same to avoid uneven magnetic field among different strands.

The 3D litz PCB routing technique may be extended and applied to a variable number of strands and layers for a better emulation of round litz wires. In order to evenly route through multiple layers of the PCB, the litz PCB may be composed of six-types of routing modes comprising a left-right mode, a right-left mode, an external-via-up mode, an external-via down mode, an internal-via up mode, and an internal-via down mode. The right-left mode and the left-right mode are wires (strands) that are routed directly from side to side of a copper layer. The external-via up and the external-via down mode are distributed on both sides of circuit board edges to connect between adjacent copper layers. The internal-via up and the internal-via down mode are added to the 3D litz PCB routing technique when the PCB routing method includes more than 4 layers. The internal-via up and the internal-via down mode is distributed inside the PCB routing away from the edges to connect between adjacent copper layers. The particular thickness of the copper wiring, number of stands, number of layers, and the width of the trace of the litz conductor 1355 may be selected to alter and achieve a desired performance and characteristics of the litz PCB winding 1302 incorporating the 3D litz PCB winding 1400. For example, the number of strands and the width of each strand (trace) influence the proximity effect and window space utilization and may lower a resistance factor and lower AC losses. Generally, the greater the number of strands and the smaller the width of each strand (trace) results in less influence of proximity effect, less window space utilization, lower resistance, and lower AC losses.

Still referring to FIG. 14, the 3D litz PCB routing (litz conductor 1355) include a solid winding 1440 around the four corner edges 1445. The solid winding corner allows the strands (or traces) between two solid corner edges to have the same length of litz wiring. When the traces reach the edge of the PCB printed inductor, a via and/or electrical connection between the copper layers will help the trace switch the layer and go towards another symmetric diagonal direction. The copper layer may be designed according to the skin depth to avoid the round litz wire conductor from being influenced by the skin effect from both the top and bottom surfaces of the litz PCB windings. For example, the thickness of the copper trace may be less than twice of the skin depth.

Still referring to FIG. 14, each layer of the 3D litz PCB routing includes a solid terminal pad 1455 and a castellated hole 1460. The solid terminal pad 1455 and the castellated holes 1460 of the different layers are aligned and connect the different layers of the PCB windings of a circuit board. The two solid terminal pads 1455 extend laterally from the 3D litz routing between two corner edges 1445. The two solid terminal pads 1455 are separated by a gap 1465. A distal end 1470 of the two solid terminal pads 1455 include the castellated hole 1460 that extends outwardly away from the two solid terminal pads 1455 in the opposite direction. The castellated holes 1460 provide alignment between the layers of the winding boards while establishing an electrical connection. The solid terminal pad 1455 and the castellated hole 1460 enable balancing of the winding length of the 3D litz routing for every turn.

The multiple layers of the litz conductor 1355 shown in FIG. 14 provide one conductive loop or winding for an inductor, starting at a first node (a first stack of the castellated holes 1460 and terminal pads 1455) and ending at a second node (the other stack of the castellated holes 1460 and terminal pads 1455). When multiple litz PCB windings 1302 are included in an inductor, each including a litz conductor 1355 such as shown in FIG. 14, a node of each litz conductor 1355 may be connected to a node of another litz conductor 1355 to serially connected the conductive loops formed by the respective litz conductors 1355, thereby forming a multi-loop winding (across stacked litz PCB windings 1302). A pair of terminals on the solid wire PCB winding 1300 of FIG. 13A may similarly be used to serially connect conductive loops provided by the embedded winding(s) of the PCB 1300, to thereby form a multi-loop winding (across stacked solid PCB windings 1300). In some examples, multiple serially-connected litz conductors 1355 are included within a single circuit board, providing a litz PCB winding having a multi-loop winding of litz conductors. In some examples, each two layers of the litz conductor 1355 form a “loop,” and the two loops (each set of two layers) are connected in series. Accordingly, the litz PCB winding having the litz conductor 1355 with four layers may be, in this arrangement, a two-loop winding. In other embodiments, the litz conductor 1355 is provided with more or fewer layers connected in series to provide a litz PCB winding with more or fewer loops.

Referring now to FIG. 15, a 3D litz routing 1500 including 40 strands of litz wiring and four layers of litz routing is illustrated. The 3D litz routing 1500 is an enlarged view of a section of the litz conductor 1355 of FIGS. 13B and 14. Three representative strands of a top layer of the routing 1500 are identified as strands 1501, 1502, and 1503. In FIG. 15, the strands of the top layer and of the third layer, including the strands 1501, 1502, and 1503, generally extend diagonally up and to the left (when starting from a lower portion 1504 of the routing 1500). In contrast, strands of the bottom layer and the second layer generally extend up and to the right (when starting from the lower portion 1504 of the routing).

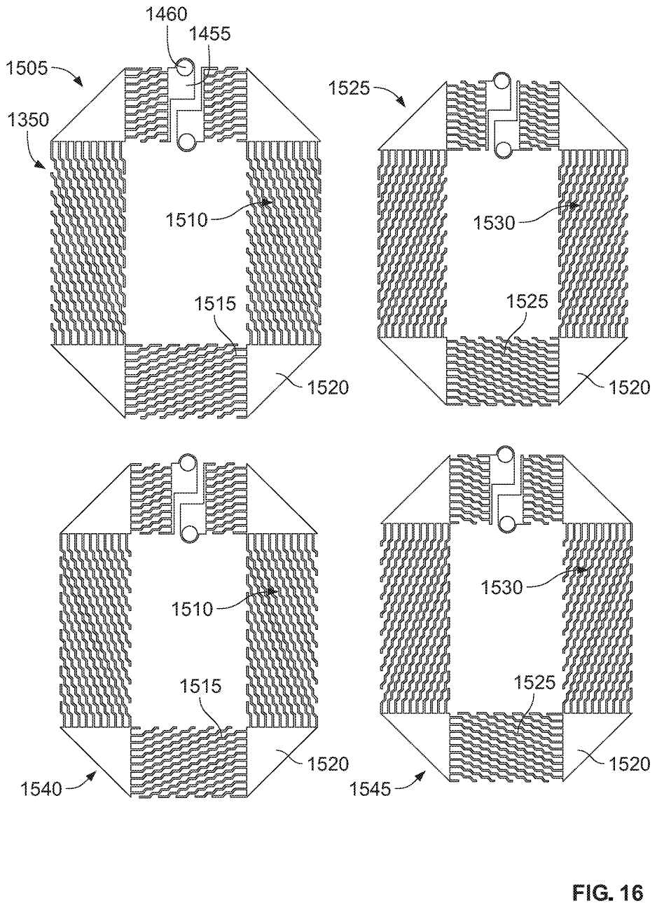

Referring now to FIG. 16, the routing 1500 is shown separated into its four layers. A top layer 1505 includes a left-right mode 1510 and a via up mode 1515 between the winding edges 1520. A second layer 1525 includes a right-left mode 1530 and a via down mode 1535 between the winding edges 1520. A third layer 1540 includes the left-right mode 1510 and the via up mode 1515 between the winding edges 1520. A bottom layer 1545 includes the right-left mode 1530 and the via down mode 1535 between the winding edges 1520. The solid terminal pads 1455 and the castellated holes 1460 align the four layers of the litz routing 1500. The four layers of litz routing 1500 forms the litz conductor 1355 of the litz PCB winding 1302 as shown in FIG. 13B. Although the example of FIG. 16 includes four layers, in some examples, more or fewer layers of litz conductor 1355 are used to form a litz PCB winding.

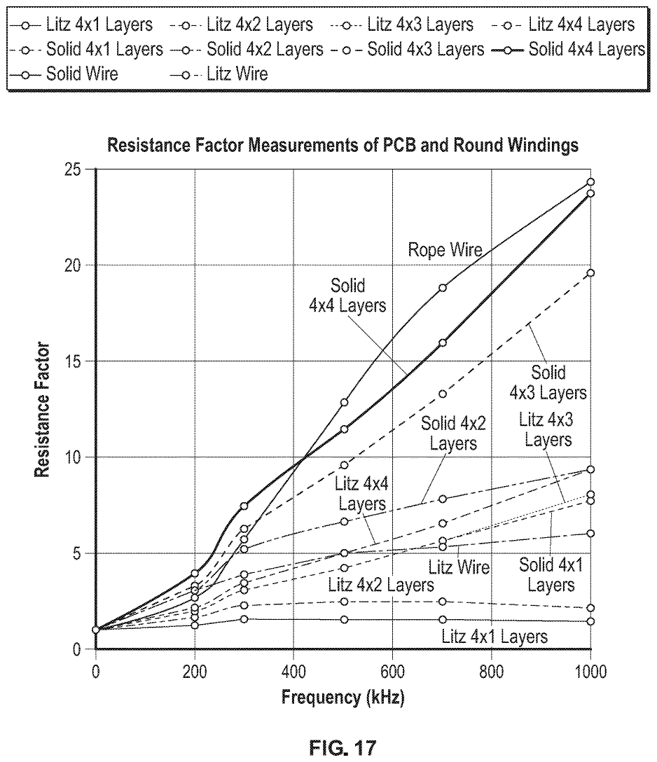

FIG. 17 illustrates resistance factor measurements of different layers of litz PCB windings 1302 and the solid PCB winding 1300 at different frequencies. The proximity effect will influence the copper losses and the resistance factor may increase with the number of stacked layer number. From the illustrated results, a litz PCB winding or litz routing structure has a smaller resistance factor that is more suitable for high frequency applications, especially when stacking multiple layers of PCB windings to form an inductor. For example, a single layer and a double layer litz routing PCB has a lower resistance factor than a regular litz wiring and a single layer of solid PCB winding at low to high frequencies, and a three-layer and four-layer litz routing PCB has a considerably lower resistance factor than solid PCB winding of equivalent layers.

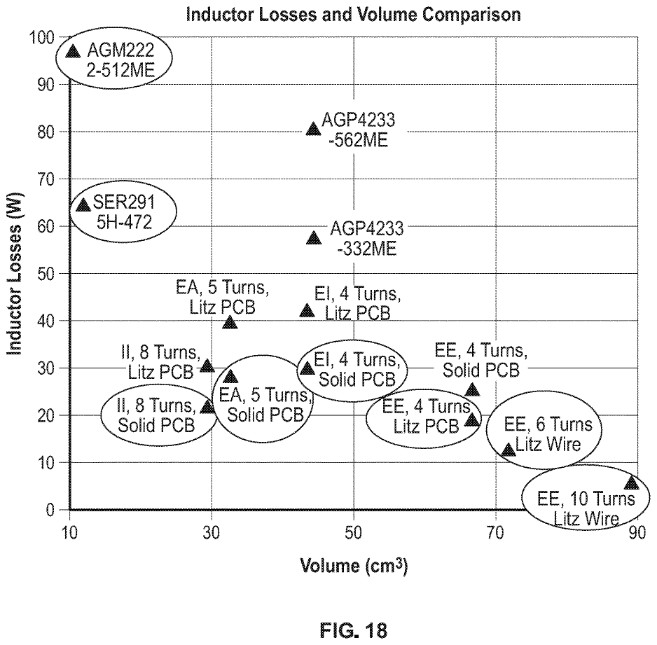

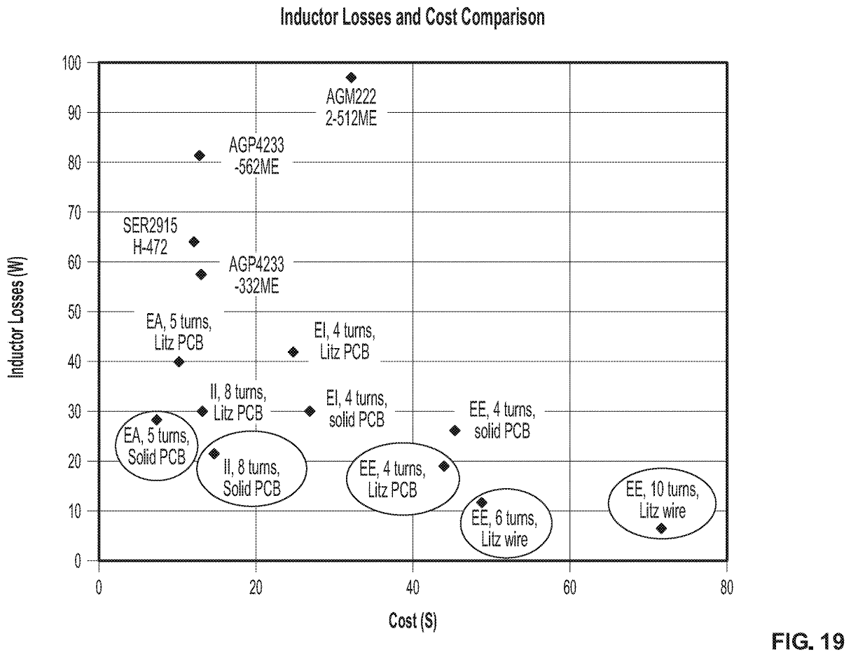

FIGS. 18 and 19 illustrate plotted data points based on experimental testing of different inductor designs with respect to inductor (power) losses, cost, and volume, where the inductors were used in power converters with on critical soft switching conditions of high frequency (100 kHz-1 MHz) and high current ripple (50A). These conditions could not be sufficiently handled by benchmarked commercial inductors due to the high loss and temperature rise. Referring to the “EE” shape core 700 with litz wire inductor 715 of FIG. 7A, the wire inductor has relatively low losses, higher cost, and higher volume. The “EE” shape core 700 with litz PCB winding 760 illustrated in FIG. 7B has relatively lower volume, higher losses, and lower cost. The “II” shape core 1000 and the “EA” shape core 900 have relatively low volume, low cost, and higher losses.

FIG. 18 illustrates the inductor losses in comparison to the volume of the inductor. Commercial inductors are shown in comparison to the different core shapes, the number of turns, and the type of winding. The litz PCB winding 1302 and the solid PCB winding 1300 on the “II” shape core 1000 and the “EA” shape core 900 demonstrates smaller volume per inductor losses.

FIG. 19 illustrates the inductor losses in comparison to the cost of fabricating the inductor. Commercial inductors are shown in comparison to the different core shapes, the number of turns, and the type of winding. The litz PCB winding 1302 and solid PCB windings 1300 on the “II” shape core 1000 and the “EA” shape core 900 demonstrates lower cost per inductor loss.

V. Combined PCB with Converter Circuitry and Inductor of LC Filter

In some embodiments, one or more components of the power converter circuitry are located on (e.g., embedded in, mounted on, etc.) a printed circuit board (PCB). These one or more components may include, for example, the electronic controller 105 or a portion thereof (e.g., the processor 145, the memory 150, one or more gate drivers, or the like), the power converter 115 (e.g., one or more of the power switching elements making up the power converter 115), or a combination thereof. In some examples, in combination with these one or more components of the power converter circuitry, an inductor of the LC filter 120 is located on the same PCB, resulting in a combined PCB. For example, the PCB may include at least one turn of the coil portion of the inductor (whether as a solid wire, as a litz conductor, or another form), and may be sandwiched between two “I” cores (i.e., as part of an inductor with an “II” shape core portion, as discussed FIGS. 10A and 10B) or otherwise integrated with another core portion shape (see, e.g., EE, EI, and EA cores of FIGS. 7A-10B and described above).

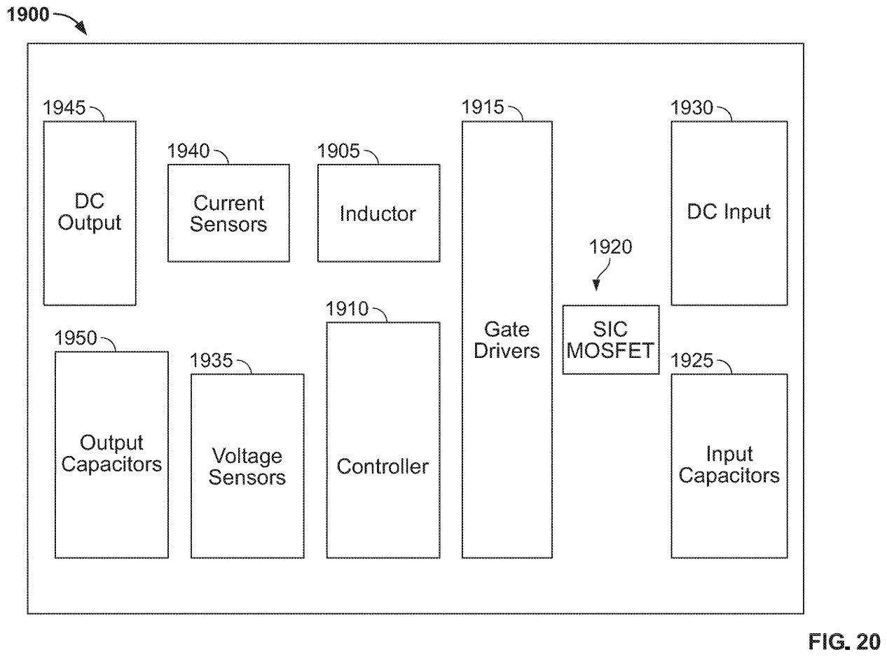

Referring to FIG. 20, a single PCB 1900 may comprise an inductor 1905 combined with one or more components. For example, one or more individual PCBs comprising the inductor 1905, the controller 1910, and/or a gate driver 1915/SiC MOSFETS 1920 may be replaced with the single PCB 1900 on which the inductor 1905 and one or more of the controller 1910, gate drivers 1915, SiC MOSFETs 1920, input capacitors 1925, DC input 1930, voltage sensors 1935, current sensors 1940, DC output 1945, or output capacitors 1950 are located. The inductor 1905 includes as a winding portion embedded in the PCB 1900, for example, one of the previously described embedded windings, such as a solid winding 1315 (of FIG. 13A) or litz conductor 1355 (of FIG. 13B). Thus, the PCB 1900 may be considered, at least in part, a solid PCB winding or a litz PCB winding of the inductor 1905. The inductor 1905 further includes as a core portion, for example, a core having an “II” shape, an “EA” shape, an “EI” shape, or an “EE” shape. Accordingly, the PCB 1900 may include an aperture (such as apertures 1325 or 1365 as shown in FIGS. 13A-B) that allows for and receives a leg of the core (e.g., in the case of an “E” shaped base). The combined single PCB 1900 can provide a more compact power converter with increased power density and a reduction in materials otherwise present for a multi-PCB implementation. In some examples, the coil portion of the inductor includes one or more additional PCBs that are stacked with the combined PCB to provide additional turns. These additional PCBs may be positioned on one side of the combined PCB (e.g., stacked on top of or below the combined PCB) or may be positioned on both sides of the combined PCB. In either case, the turn (or turns) of each PCB is conductively coupled with the turn(s) of the other PCBs in the stack, and turns of the PCBs are aligned or approximately concentric. See, for example, the stacks of PCBs (and corresponding turns of the inductor) illustrated in FIGS. 7B, 8B, 9B, and 10B.

As provided herein, an inductor for an LC filter in a power converter may have various characteristics and properties related both the winding portion and core portion, including the sizes, shapes, number of turns, winding type, and the like. The particular combination of these characteristics may be selected to meet requirements or preferences for a particular design. Some considerations for such design are now provided. Generally, inductance decreases linearly with current level, and inductance increases because magnetic energy goes with current squared. The inductance for the inductor of the LC filter 120, can be designed around the area product of energy −½(Li\hat{ }2)\hat{ }(¾).

Scaling relationships can be provided by the following equations, which describe the laws of inductors (and magnetics):

$${A}_{w} {A}_{i} = \frac{{LI}_{p} {I}_{RMS}}{{k}_{w} {J}_{RMS} {B}_{s}} ∝ {V}_{l}^{4 / 3}$$

where A_{w} and Aᵢ are the winding and iron area, respectively; L is the inductance, Iₚ, I_{RMS}, and J_{RMS} are the peak current, the RMS current, and the current density, respectively; Bₛ is the saturation induction; and Vₗ is the inductor volume. Further,

$${V}_{l} ∝ {( {A}_{w} {A}_{i} )}^{3 / 4} ∝ {E}_{l}^{3 / 4} = {( \frac{1}{2} {LI}^{2} )}^{3 / 4}$$

where Eₗ is the stored energy in the inductor.

Accordingly, changing the number of turns, for example, to increase the parallel or series turns, results in different levels of current or inductance. As used herein with respect to an inductor, a “turn” may also be referred to as a conductor loop.

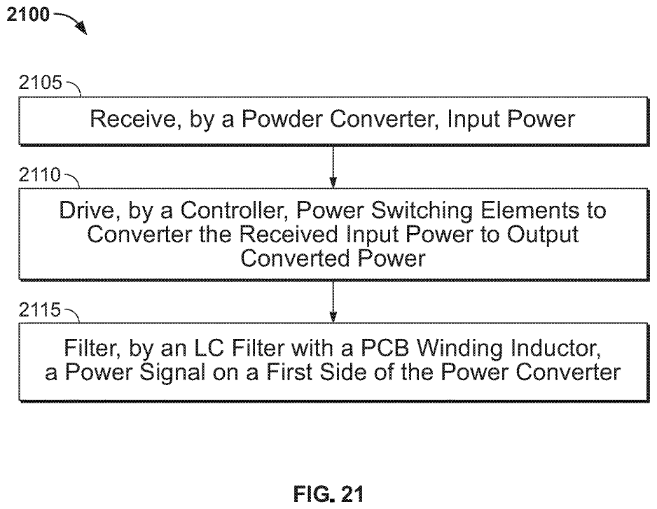

FIG. 21 illustrates a process 2100 for power conversion. The process 2100 is described as being carried out by the power converter system 100 implemented with the power converter 200 as the power converter 115 and including one of the disclosed inductors provided herein as the switch side inductor (or inductor for each phase as shown in FIG. 3) of the filter 120, 245, 308. However, in some embodiments, the process 2100 may be implemented by another power converter system or by the power converter system 100 using another power converter as the power converter 115. Additionally, although the blocks of the process 2100 are illustrated in a particular order, in some embodiments, one or more of the blocks may be executed partially or entirely in parallel, may be executed in a different order than illustrated in FIG. 21, or may be bypassed.

In block 2105, a power converter including power switching elements (e.g., the power converter system 100) receives input power. For example, with refence to FIG. 2, the DC voltage terminals (e.g., DC voltage terminals 220) receive an input DC voltage, where the DC voltage terminals include a positive DC terminal 222 and a negative DC terminal 224 located on a DC side of the power converter. The input DC voltage may be provided by a DC source, such as battery, capacitor, ultracapacitor, DC power supply from rectified AC source (e.g., AC grid power converted to DC power by a diode bridge rectifier), or the like. Alternatively, the interface terminals (e.g., interface terminals 225) receive an AC input voltage. The AC input voltage may be provided by an AC source, such as a power grid, an AC generator (e.g., an engine-driven generator), or the like.

In block 2110, a controller (e.g., the controller 105) drives a power switching element pair to convert the received input power. In the case of the received input power being DC power, the power switching elements convert the DC power to AC power for output via the interface terminals 225. In the case of the received input power being AC power, the power switching elements converter the AC power to DC power for output via the DC terminals 220. In some examples, the controller 105 drives the power switching elements with variable frequency critical soft switching (VFCSS) as described above. To drive the power switching elements, the controller 105 outputs PWM control signals to a gate terminal of the power switching elements. To generate the PWM control signals to drive the power switching elements (e.g., the switches 235, 240), the controller 105 may sense or estimate operational characteristics of the power converter, and increase or decrease the duty cycle (and, in the case of VFCSS, the frequency) of the PWM control signals accordingly. For example, the controller 105 may implement a proportional integral derivative (PID) controller that receives an input voltage command (a reference voltage) for the converter and a measured voltage at the output of the converter (e.g., at the interface terminals 225). The PID controller may then generate a reference current signal based on the difference between the reference voltage and the measured voltage, using standard PID techniques. Generally, if measured voltage is below the reference voltage, the reference current signal would be increased, and vice-versa. The reference current may then be translated to reference duty cycle value (e.g., a value between 0-100%) indicating the percentage of each switching cycle that the upper switch (M1) 135 should be ON and OFF, and likewise, the percentage of each switching cycle that the lower switch (M2) 140 should be OFF. Generally, the duty cycle of the upper switch (M1) 135 increases as the reference current increases, within certain operational boundaries. The controller 105 (or a gate driver thereof) may then generate the respective PWM control signals according to the reference duty cycle. This PID controller is just one example of a control scheme to generate control signals to drive the power switching elements. In other examples, in block 2110, the controller 105 implements other control schemes, such as a cascaded PID control, a state-based control, a model predictive control (MPC), or another regulating control scheme to drive the power switching elements of the modified converter 210. For example, the controller 105 may implement VFCSS using another control scheme.

In block 2115, an LC filter including an inductor and a capacitor that is coupled to a first side of the power converter (e.g., LC filter 120, 245, 308) filters a power signal on the first side of the power converter. The power signal received by the LC filter may have a current ripple of at least 200% peak-to-peak ripple with respect to local average current.

The switch side inductor of the LC filter (e.g., switch side inductor 250 of the LC filter 120, 245, 308) may be implemented as one of the inductors provided herein, such as one of the inductors comprising a PCB winding, whether solid PCB winding (see, e.g., FIG. 13A) or litz PCB winding (see, e.g., FIG. 13B). The filtered output voltage may be either AC voltage provided to the interface terminals 225 or DC voltage provided to the DC terminals 220, depending on the control or driving of the power switching elements.

As noted above, in some examples, an LC filter 120, 245 includes a further inductor coupled between the filter node 260 and the positive interface terminal 227, thereby providing an LCL filter. Additionally, in some examples, the LC filter further includes an upper capacitor (see upper capacitor 215 of FIG. 2), which can reduce ripple current by providing a path for ripple currents to propagate between the DC terminals and the interface terminals and cancel at least a portion of differential mode current ripple between the DC terminals and the interface terminals. In some examples, each power switching element (e.g., the upper and lower switches 235, 240) include a drain-source capacitor (C_{DS}) coupled across the respective source and drain terminals of the switches 235, 240 (see, e.g., capacitor 265a-b of FIG. 2). In some examples, the LC filter of the process 2100 is included in a combined PCB, as provided with respect to FIG. 20.

Performing the various techniques and operations described herein may be facilitated by a controller device (e.g., a processor-based computing device). Such a controller device may include a processor-based device such as a computing device, and so forth, that may include a central processor unit (CPU) or a processing core. In addition to the CPU or processing core, the system includes main memory, cache memory, and bus interface circuits. The controller device may include a memory storage device, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, the implementation of a voltage converter (e.g., by controlling the switching devices of, for example, a non-isolated three-phase DC/AC voltage converter system). The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

### FURTHER EXAMPLES

Example 1: A method, apparatus, and/or non-transitory computer-readable medium storing processor-executable instructions for a non-isolated power converter system, the system comprising: a power converter including power switching elements; a controller configured to drive the power switching elements to convert received power and to output converted power, the controller configured to drive the power switching elements using variable frequency soft switching; and a filter including an inductor and a capacitor, the filter coupled to a first side of the power converter to filter a power signal on the first side of the power converter, the power signal received by the filter having a current ripple of at least 200% peak-to-peak ripple with respect to local average current, wherein the inductor includes a core portion and a winding portion, wherein the winding portion includes a winding embedded in a printed circuit board.

Example 2: The method, apparatus, and/or non-transitory computer readable medium of Example 1, wherein each loop of the winding is a wire conductor with a solid cross-section.

Example 3: The method, apparatus, and/or non-transitory computer readable medium of any of Examples 1 to 2, wherein the winding embedded in the printed circuit board forms a litz PCB in which the winding includes multiple layers of parallel strands routed in the printed circuit board.

Example 4: The method, apparatus, and/or non-transitory computer readable medium of any of Examples 1 to 3, wherein the litz PCB includes at least one or more layers of parallel strands, and each strand of the parallel strands is a conductive trace.

Example 5: The method, apparatus, and/or non-transitory computer readable medium of any of Examples 1 to 4, wherein the winding portion includes one or more additional litz PCBs, each additional litz PCB including an additional winding including multiple layers of parallel strands routed in an additional printed circuit board.

Example 6: The method, apparatus, and/or non-transitory computer readable medium of any of Examples 1 to 5, wherein the core portion includes a first core portion on an opposite side of the winding portion as a second core portion, wherein the first core portion and the second core portion include planar surfaces facing the conductor loop and substantially parallel to the printed circuit board.

Example 7 The method, apparatus, and/or non-transitory computer readable medium of any of Examples 1 to 6, wherein the core portion includes a first core portion opposite an open air portion, the first core portion having a base portion and three legs extending therefrom, wherein a middle leg of the three legs extends through the opening defined by the conductor loop.

Example 8: The method, apparatus, and/or non-transitory computer readable medium of any of Examples 1 to 7, wherein the printed circuit board further includes, located thereon, one or more of: the controller, or one or more of the power switching elements.

Example 9: The method, apparatus, and/or non-transitory computer readable medium of any of Examples 1 to 8, wherein the first side of the power converter is one selected from the group of an DC output side for DC/DC converting, an AC output side for DC/AC inverting, and an AC input side for AC/DC rectifying.

Example 10: A method, apparatus, and/or non-transitory computer-readable medium storing processor-executable instructions for a method of power conversion, the method comprising: receiving, by a power converter including power switching elements, input power; driving, by a controller, the power switching elements to convert received input power to output converted power, the controller configured to drive the power switching elements using variable frequency soft switching; and filtering, by an LC filter including an inductor and a capacitor that is coupled to a first side of the power converter, a power signal on the first side of the power converter, the power signal received by the filter having a current ripple of at least 200% peak-to-peak ripple with respect to local average current, wherein the inductor includes a core portion and a winding portion, wherein the winding portion includes a winding embedded in a printed circuit board.

Example 11: A method, apparatus, and/or non-transitory computer-readable medium storing processor-executable instructions for an inductor for a filter in a non-isolated power converter system, the inductor comprising: a core portion; a winding portion that forms an inductor with the core portion, the winding portion including a winding embedded in a printed circuit board and having a first terminal and a second terminal, the winding embedded in the printed circuit board forming a litz PCB in which the winding includes multiple layers of parallel strands routed in the printed circuit board.

Example 12: The method, apparatus, and/or non-transitory computer readable medium of Example 11, wherein the litz PCB includes at least two layers of parallel strands, and each strand of the parallel strands is a conductive trace.

Example 13: The method, apparatus, and/or non-transitory computer readable medium of any of Examples 11 to 12, wherein the winding portion includes one or more additional litz PCBs, each additional litz PCB including an additional winding including multiple layers of parallel strands routed in an additional printed circuit board.

Example 14: The method, apparatus, and/or non-transitory computer readable medium of any of Examples 11 to 13, wherein the core portion includes a first core portion on an opposite side of the winding portion as a second core portion, wherein the first core portion and the second core portion include planar surfaces facing the conductor loop and substantially parallel to the printed circuit board.

Example 15: The method, apparatus, and/or non-transitory computer readable medium of any of Examples 11 to 14, wherein the core portion includes a first core portion opposite an open air portion, the first core portion having a base portion and three legs extending therefrom, wherein a middle leg of the three legs extends through the opening defined by the conductor loop.

Example 16: The method, apparatus, and/or non-transitory computer readable medium of any of Examples 11 to 15, wherein the inductor is part of an LC filter that filters a power signal of a power converter, and wherein the printed circuit board further includes, located thereon, one or more of: one or more of the power switching elements of a power converter, or a controller configured to drive the one or more power switching elements of the power converter.

Example 17: The method, apparatus, and/or non-transitory computer readable medium of any of Examples 11 to 16, wherein the power converter is one selected from the group of a DC/DC converter, DC/AC inverter, and an AC/DC rectifier.

Example 18: A method, apparatus, and/or non-transitory computer-readable medium storing processor-executable instructions for an inductor for a filter in a non-isolated power converter system, the inductor comprising: a winding portion including a winding embedded in a printed circuit board, the winding forming a conductor loop and including a first terminal and a second terminal; and a core portion that forms an inductor with the winding portion, the core portion including a first core portion on an opposite side of the winding portion as a second core portion, wherein the first core portion and the second core portion including planar surfaces facing the conductor loop and substantially parallel to the printed circuit board.

Example 19: The method, apparatus, and/or non-transitory computer readable medium of Example 18, wherein the core portion includes a first core portion on an opposite side of the winding portion as a second core portion, wherein a plurality of printed circuit board is sandwiched between the first core portion and the second core portion.

Example 20: The method, apparatus, and/or non-transitory computer readable medium of any of Examples 18 to 19, wherein the conductor loop of the winding is a wire conductor with a solid cross-section.

Example 21: The method, apparatus, and/or non-transitory computer readable medium of any of Examples 18 to 20, wherein the winding embedded in the printed circuit board forms a litz PCB in which the winding includes multiple layers of parallel strands routed in the printed circuit board.

Example 22: The method, apparatus, and/or non-transitory computer readable medium of any of Examples 18 to 21, wherein the litz PCB includes at least four layers of parallel strands, and each strand of the parallel strands is a conductive trace.

Example 23: The method, apparatus, and/or non-transitory computer readable medium of any of Examples 18 to 22, wherein the winding portion includes one or more additional litz PCBs, each additional litz PCB including an additional winding including multiple layers of parallel strands routed in an additional printed circuit board.

Example 24: The method, apparatus, and/or non-transitory computer readable medium of any of Examples 18 to 23, wherein the inductor is part of an LC filter that filters a power signal of a power converter, and wherein the printed circuit board further includes, located thereon, one or more of: one or more of the power switching elements of a power converter, or a controller configured to drive the one or more power switching elements of the power converter.

Example 25: The method, apparatus, and/or non-transitory computer readable medium of any of Examples 18 to 24, wherein the power converter is one selected from the group of a DC/DC converter, DC/AC inverter, and an AC/DC rectifier.

Example 26: A method, apparatus, and/or non-transitory computer-readable medium storing processor-executable instructions for an inductor for a filter in a non-isolated power converter system, the inductor comprising: a winding portion including a winding embedded in a printed circuit board, the winding forming a conductor loop and including a first terminal and a second terminal; a core portion that forms an inductor with the winding portion, the core portion including a first core portion opposite an open air portion, the first core portion having a base portion and three legs extending therefrom, wherein a middle leg of the three legs extends through the opening defined by the conductor loop.

Example 27: The method, apparatus, and/or non-transitory computer readable medium of Example 26, wherein an outer most legs of the first core portion is parallel with the middle leg of the three legs, the outer most legs having a different thickness from the middle leg.

Example 28: The method, apparatus, and/or non-transitory computer readable medium of any of Examples 26 to 27,

Example 29: The method, apparatus, and/or non-transitory computer readable medium of any of Examples 26 to 28, wherein the conductor loop of the winding is a wire conductor with a solid cross-section.

Example 30: The method, apparatus, and/or non-transitory computer readable medium of any of Examples 26 to 29, wherein the winding embedded in the printed circuit board forms a litz PCB in which the winding includes multiple layers of parallel strands routed in the printed circuit board.

Example 31: The method, apparatus, and/or non-transitory computer readable medium of any of Examples 26 to 30, wherein the litz PCB includes at least four layers of parallel strands, and each strand of the parallel strands is a conductive trace.

Example 32: The method, apparatus, and/or non-transitory computer readable medium of any of Examples 26 to 31, wherein the winding portion includes one or more additional litz PCBs, each additional litz PCB including an additional winding including multiple layers of parallel strands routed in an additional printed circuit board.

Example 33: The method, apparatus, and/or non-transitory computer readable medium of any of Examples 26 to 32, wherein the inductor is part of an LC filter that filters a power signal of a power converter, and wherein the printed circuit board further includes, located thereon, one or more of: one or more of the power switching elements of a power converter, or a controller configured to drive the one or more power switching elements of the power converter.

Example 34: The method, apparatus, and/or non-transitory computer readable medium of any of Examples 26 to 33, wherein the power converter is one selected from the group of a DC/DC converter, DC/AC inverter, and an AC/DC rectifier.

Example 35: A method, apparatus, and/or non-transitory computer-readable medium storing processor-executable instructions for a non-isolated power converter system, the system comprising: a power converter including power switching elements; a controller configured to drive the power switching elements to convert received power and to output converted power; a filter including an inductor and a capacitor, the filter coupled to a first side of the power converter to filter a power signal on the first side of the power converter, wherein the inductor includes a core portion and a winding portion; and a printed circuit board, the printed circuit board having embedded thereon a winding of the winding portion and the printed circuit board having located thereon one or more of: the controller, or one or more of the power switching elements.

Example 36: The method, apparatus, and/or non-transitory computer readable medium of Example 35, wherein each loop of the winding is a wire conductor with a solid cross-section.

Example 37: The method, apparatus, and/or non-transitory computer readable medium of any of Examples 35 to 36, wherein the winding embedded in the printed circuit board forms a litz PCB in which the winding includes multiple layers of parallel strands routed in the printed circuit board.

Example 38: The method, apparatus, and/or non-transitory computer readable medium of any of Examples 35 to 37, wherein the litz PCB includes at least four layers of parallel strands, and each strand of the parallel strands is a conductive trace.

Example 39: The method, apparatus, and/or non-transitory computer readable medium of any of Examples 35 to 38, wherein the winding portion includes one or more additional litz PCBs, each additional litz PCB including an additional winding including multiple layers of parallel strands routed in an additional printed circuit board.

Example 40: The method, apparatus, and/or non-transitory computer readable medium of any of Examples 35 to 39, wherein the core portion includes a first core portion on an opposite side of the winding portion as a second core portion, wherein the first core portion and the second core portion include planar surfaces facing the conductor loop and substantially parallel to the printed circuit board.

Example 41: The method, apparatus, and/or non-transitory computer readable medium of any of Examples 35 to 40, wherein the core portion includes a first core portion opposite an open air portion, the first core portion having a base portion and three legs extending therefrom, wherein a middle leg of the three legs extends through the opening defined by the conductor loop.

Example 42: The method, apparatus, and/or non-transitory computer readable medium of any of Examples 35 to 41, wherein the printed circuit board further includes, located thereon, one or more of: the controller, or one or more of the power switching elements.

Example 43: The method, apparatus, and/or non-transitory computer readable medium of any of Examples 35 to 42, wherein the power converter is one selected from the group of a DC/DC converter, DC/AC inverter, and an AC/DC rectifier.

Example 44: A method, apparatus, and/or non-transitory computer-readable medium storing processor-executable instructions for a method of power conversion, the method comprising: receiving, by a power converter including power switching elements, input power; driving, by a controller, the power switching elements to convert received input power to output converted power, one or more of (i) the controller, or (ii) one or more of the power switching elements being located on a printed circuit board; filtering, by an LC filter including an inductor and a capacitor that is coupled to a first side of the power converter, a power signal on the first side of the power converter, wherein the inductor includes a core portion and a winding portion, wherein the winding portion includes a winding embedded in the printed circuit board.

Example 45: The method, apparatus, and/or non-transitory computer readable medium of Example 44, wherein the driving, by the controller, the power switching elements to convert received input power to output converted power includes at least one selected from the group of: converting the input power from a first DC voltage level to a second DC voltage level for the output converted power, wherein the first side of the power converter is a DC output side, converting the input power from DC to AC for the output converted power, wherein the first side of the power converter is an AC output side, or converting the input power from AC to DC for the output converted power, wherein the first side of the power converter is an AC input side.

1.-18. (canceled)

19. An inductor for a filter in a power converter system, the inductor comprising:
a core portion; and
a winding portion that forms an inductor with the core portion, the winding portion including a winding embedded in a printed circuit board and having a first terminal and a second terminal, the winding embedded in the printed circuit board forming a litz PCB in which the winding includes multiple layers of parallel strands routed in the printed circuit board.

20. The inductor of claim 19, wherein the litz PCB includes at least two layers of parallel strands, and each strand of the parallel strands is a conductive trace.

21. The inductor of claim 19, wherein the winding portion includes one or more additional litz PCBs, each additional litz PCB including an additional winding including multiple layers of parallel strands routed in an additional printed circuit board.

22. The inductor of claim 19, wherein the core portion includes a first core portion on an opposite side of the winding portion as a second core portion, wherein the first core portion and the second core portion include planar surfaces facing a conductor loop and substantially parallel to the printed circuit board.

23. The inductor of claim 19, wherein the core portion includes a first core portion opposite an open air portion, the first core portion having a base portion and three legs extending therefrom, wherein a middle leg of the three legs extends through an opening defined by a conductor loop.

24. The inductor of claim 19, wherein the inductor is part of an LC filter that filters a power signal of a power converter, and wherein the printed circuit board further includes, located thereon, one or more of:
one or more of the power switching elements of a power converter, or
a controller configured to drive the one or more power switching elements of the power converter.

25. The inductor of claim 19, wherein the power converter is one selected from the group of a DC/DC converter, DC/AC inverter, and an AC/DC rectifier.

26.-59. (canceled)

60. A power converter system, the system comprising:
a power converter including power switching elements;
a controller configured to drive the power switching elements to convert received power and to output converted power; and
a filter including an inductor and a capacitor, the filter coupled to the power converter, wherein the inductor includes:
a core portion; and
a winding portion that forms an inductor with the core portion, the winding portion including a winding embedded in a printed circuit board and having a first terminal and a second terminal, the winding embedded in the printed circuit board forming a litz PCB in which the winding includes multiple layers of parallel strands routed in the printed circuit board.

61. The power converter system of claim 60, wherein the litz PCB includes at least two layers of parallel strands, and each strand of the parallel strands is a conductive trace.

62. The power converter system of claim 60, wherein the winding portion includes one or more additional litz PCBs, each additional litz PCB including an additional winding including multiple layers of parallel strands routed in an additional printed circuit board.

63. The power converter system of claim 60, wherein the core portion includes a first core portion on an opposite side of the winding portion as a second core portion, wherein the first core portion and the second core portion include planar surfaces facing a conductor loop formed by the winding and substantially parallel to the printed circuit board.

64. The power converter system of claim 60, wherein the core portion includes a first core portion opposite an open air portion, the first core portion having a base portion and three legs extending therefrom, wherein a middle leg of the three legs extends through an opening defined by a conductor loop formed by the winding.

65. The power converter system of claim 60, wherein the inductor is part of an LC filter that filters a power signal of a power converter, and wherein the printed circuit board further includes, located thereon, one or more of the power switching elements of the power converter.

66. The power converter system of claim 60, wherein the inductor is part of an LC filter that filters a power signal of a power converter, and wherein the printed circuit board further includes, located thereon, a controller configured to drive the one or more power switching elements of the power converter.

67. The power converter system of claim 60, wherein the power converter is one selected from the group of a DC/DC converter, DC/AC inverter, and an AC/DC rectifier.

68. A method of power conversion, the method comprising:
receiving, by a power converter including power switching elements, input power;
driving, by a controller, the power switching elements to convert received input power to output converted power; and
filtering, by an LC filter including an inductor and a capacitor that is coupled to a first side of the power converter, a power signal on the first side of the power converter,
wherein the inductor includes a core portion and a winding portion, wherein the winding portion includes a winding embedded in a printed circuit board,
wherein the winding embedded in the printed circuit board forms a litz PCB in which the winding includes multiple layers of parallel strands routed in the printed circuit board.

69. The method of claim 68, wherein the litz PCB includes at least two layers of parallel strands, and each strand of the parallel strands is a conductive trace.

70. The method of claim 68, wherein the winding portion includes one or more additional litz PCBs, each additional litz PCB including an additional winding including multiple layers of parallel strands routed in the additional litz PCB.

71. The method of claim 68, wherein the core portion includes a first core portion on an opposite side of the winding portion as a second core portion, wherein the first core portion and the second core portion include planar surfaces facing a conductor loop formed by the winding and parallel to the printed circuit board.

72. The method of claim 68, wherein the core portion includes a first core portion opposite an open air portion, the first core portion having a base portion and three legs extending therefrom, wherein a middle leg of the three legs extends through an opening defined by a conductor loop formed by the winding.
